(19) United States
(12) Patent Application Publication
(10) Pub. No.: US 2025/0389976 A1
(43) Pub. Date: Dec. 25, 2025

(54) METHODS OF MANUFACTURING CONTACT LENSES FOR CORRECTING OPTICAL ABERRATIONS

(71) Applicant: JOURNEY1 INC, South San Francisco, CA (US)

(72) Inventors: Yair ALSTER, Tel Aviv (IL); Omer RAFAELI, Rishpon (IL); Eugene DE JUAN, JR., SAN FRANCISCO, CA (US); Matt CLARKE, SAN FRANCISCO, CA (US)

(73) Assignee: JOURNEY1 INC, South San Francisco, CA (US)

(21) Appl. No.: 19/143,451

(22) PCT Filed: Dec. 22, 2023
(86) PCT No.: PCT/US2023/085693

§ 371 Date: Jun. 26, 2025

Related U.S. Application Data
(60) Provisional application No. 63/436,050, filed on Dec. 29, 2022.

(51) Int. Cl. G02C 7/04

(52) U.S. Cl. CPC G02C 7/049

(57) ABSTRACT

Provided herein are a soft contact lens for correcting an ocular refractive error of an eye, the soft contact lens comprising a vaulted portion and a specialty feature.

### CROSS-REFERENCE

This application claims the benefit of U.S. Provisional Application No. 63/436,050, filed Dec. 29, 2022, which is incorporated herein by reference in its entirety.

### BACKGROUND

A person having a refractive error of the eye often suffers from poor vision, such as a blurred or distorted vision as the eye is unable to focus the light onto the retina. Such poor vision may be corrected by eyeglasses, contact lenses, and/or surgery. Such refractive errors may include astigmatism, myopia, and/or presbyopia. For those having one or more refractive errors, more specialized contact lenses with additional features and corrections may be needed to correct the one or more refractive errors. Due to the additional fitting criteria, a large variety of specialized contact lenses meeting these additional criteria need to be manufactured and stored. In addition, the fitting of these specialized contact lenses may be more time-consuming than fitting of conventional contact lenses. Further, current contact lenses may not be suitable to correct one or more refractive errors to a high degree of satisfaction due to a complexity of the refractive errors. Therefore, there is a need for contact lenses that can correct one or more refractive errors as well as solutions to reduce the number of different contact lenses needed to be manufactured and stored.

### SUMMARY

A refractive error of the eye often results in poor vision, such as a blurred or distorted vision, for the person having the refractive error as the eye is unable to focus the light onto the retina. Common refractive errors include, but are not limited to, myopia (nearsightedness), hyperopia (farsightedness), presbyopia, and astigmatism. Astigmatism is often caused by an irregularly shaped cornea, where the non-spherical or variable curvature of the cornea causes light rays to focus at different points on the retina. In some cases, astigmatism may be associated with other eye conditions, such as keratoconus, corneal lesions, scars, and prior corneal surgery, or other refractive errors. In some cases, refractive errors comprise higher order aberrations (e.g., third or higher) that are difficult to correct by cylinder or spherical corrections. These higher order aberrations include, but are not limited to, corneal coma, trefoil aberration, and spherical aberration.

For those having one or more refractive errors, specialized contact lenses may be needed to correct the one or more refractive errors. For those having astigmatism, specialized contact lenses, including but not limited to toric soft lenses and rigid gas permeable (RGP) contact lenses, may be needed to correct the refractive error in at least two meridians. For those having presbyopia, specialized contact lenses, including but not limited to multifocal contact lenses, may be needed to correct the refractive error. Due to the various fitting criteria to correct these refractive errors, a large variety of specialized contact lenses meeting these additional criteria may need to be manufactured and stored. In addition, the fitting of these specialized contact lenses may be more time-consuming than fitting of conventional contact lenses. Further, current contact lenses may not be suitable to correct one or more refractive errors to a high degree of satisfaction due to a complexity of the refractive errors. In some cases, the subject wearing a contact lens may experience dizziness or blurred correction due to the correction needed. The toric contact lenses often require stabilization to position the correcting cylinder at the appropriate axis on the eye, which takes time and may cause temporary discomfort and/or blurred vision for the user. In some cases, a low tolerance of error that is required in manufacturing contact lens for correcting high power correction may be difficult to achieve consistently. Therefore, there is a need for contact lenses that can correct one or more refractive errors as well as providing solutions to reduce the number of different contact lenses needed to be manufactured and stored.

Provided herein are specialized soft contact lenses for correcting an ocular refractive error of an eye comprising at least a vaulted portion and a specialty feature. Usually, the vaulted portion may form a tear film lens in the lenticular volume formed between the vaulted portion and the cornea when the lens is worn on the eye. In some cases, the tear film lens formed by the vaulted portion provides at least a part of the correction of the ocular refractive error. In some cases, the tear film lens formed by the vaulted portion provides at least a part of correction of astigmatism. Often, the specialty feature comprises a toric feature, or a multifocal feature, or a combination thereof. In some cases, the toric feature comprises a prism-ballast, a peri-ballast, a back toric element, or a thin-zone design, or a combination thereof. In some cases, the multifocal feature comprises a bifocal feature, a trifocal feature, or a progressive feature, or a combination thereof. In some cases, the multifocal feature comprises an aspheric multifocal feature, a concentric multifocal feature, or a segmented multifocal feature, or a combination thereof. In some cases, the specialty feature comprises a power correction feature.

Having multiple features for correcting the ocular refractive error in a contact lens may have several advantages over conventional contact lenses. In some cases, the total corrective power provided by the contact lens may be shared amongst the different features (e.g., vaulted portion, multifocal feature, and/or toric feature). In some cases, if a vision correction is difficult to achieve by a toric lens or a multifocal lens alone, especially in subjects requiring a higher power correction, having a vaulted portion may be beneficial to share the level of correction. In some cases, a contact lens having both a vaulted portion and a specialized feature may offer an improved vision correction than a contact lens having only a specialized feature without a vaulted portion. In some cases, the improved vision correction comprises an improvement in a cylindrical correction, a spherical correction, a near vision correction, a far vision correction, or a performance (e.g., comfort). A subject who usually experiences dizziness, sensitivity, and/or discomfort with a contact lens may experience reduced dizziness, sensitivity, and/or discomfort with the contact lens with multiple features. In some cases, a subject who needs a higher corrective power may be more likely to experience dizziness, sensitivity, and/or discomfort in wearing a contact lens. In some cases, the subject may experience reduced dizziness, sensitivity, and/or discomfort when wearing the contact lens as provided herein as compared to a contact lens with a single feature (e.g., high power toric lens).

In some cases, manufacturing a contact lens with multiple features as provided herein may allow for a higher tolerance for error in manufacturing. In some cases, manufacturing a contact lens with multiple features with a feature at a lower power than in a contact lens with only a single feature may allow for a higher tolerance for error in manufacturing. For example, the specialty feature may be made for a lower power in a contact lens with a vaulted portion than in a contact lens without the vaulted portion.

Provided herein is a soft contact lens for correcting an ocular refractive error of an eye, the soft contact lens comprising a vaulted portion and a specialty feature.

In some embodiments, a portion of the specialty feature and a portion of the vaulted portion overlaps in an optical portion of the soft contact lens.

In some embodiments, the specialty feature and the vaulted portion do not overlap.

In some embodiments, the soft contact lens comprises a continuous body (e.g., unibody).

In some embodiments, the soft contact lens is made of a single material.

In some embodiments, the single material comprises a hydrogel.

In some embodiments, the single material comprises a silicone.

In some embodiments, the single material comprises a silicone hydrogel.

In some embodiments, the specialty feature comprises a multifocal feature.

In some embodiments, the multifocal feature comprises a bifocal feature, a trifocal feature, or a progressive feature.

In some embodiments, the multifocal feature comprises an aspheric multifocal feature. In some embodiments, the multifocal feature comprises a concentric multifocal feature.

In some embodiments, the multifocal feature comprises a segmented multifocal feature.

In some embodiments, the multifocal feature is configured to correct presbyopia.

In some embodiments, the multifocal feature provides a correction ranging from about −6 diopter (D) to about +6 D.

In some embodiments, the multifocal feature provides a correction of at least about −6 diopter (D), −5.75 D, −5.5 D, −5.25 D, −5 D, −4.75 D, −4.5 D, −4.25 D, −4 D, −3.75 D, −3.5 D, −3.25D, −3 D, −2.75D, −2.5 D, −2.25 D, −2 D, −1.75D, −1.5 D, −1.25D, −1 D, −0.75 D, −0.5 D, −0.25 D, +0.25 D, +0.5 D, +0.75 D, +1 D, +1.25 D, +1.5 D, +1.75 D, +2 D, +2.25 D, +2.5 D, +2.75 D, +3 D, +3.25 D, +3.5 D, +4 D, +4.25 D, +4.5 D, +4.75 D, +5 D, +5.25 D, +5.5 D, +5.75 D, or +6 D.

In some embodiments, the multifocal feature provides at least about 10%, 20%, 30%, 40%, 50%, 60%, 70%, 80%, or 90% of total power correction.

In some embodiments, the multifocal feature is on an anterior portion of the soft contact lens.

In some embodiments, the specialty feature comprises a toric feature.

In some embodiments, the toric feature comprises a prism-ballast, a peri-ballast, a back toric element, or a thin-zone design, or a combination thereof.

In some embodiments, the toric feature is located in a peripheral portion of the soft contact lens.

In some embodiments, the toric feature provides a cylindrical correction.

In some embodiments, the cylindrical correction is provided by the toric feature and a tear film lens formed in between the vaulted portion and the cornea.

In some embodiments, the toric feature provides a correction of at least about ranging from about −4 D to about +4 D.

In some embodiments, the toric feature provides at least about 10%, 20%, 30%, 40%, 50%, 60%, 70%, 80%, or 90% of total power correction.

In some embodiments, the toric feature provides at least a portion of a cylindrical power correction.

In some embodiments, the toric feature provides at least about 10%, 20%, 30%, 40%, 50%, 60%, 70%, 80%, or 90% of total cylindrical power correction.

In some embodiments, the vaulted portion is configured to vault over a portion of a cornea.

In some embodiments, a portion of the vaulted portion is in an optical portion of the soft contact lens.

In some embodiments, the vaulted portion is configured to be suspended above the cornea when worn on the eye.

In some embodiments, the vaulted portion is configured to form a free volume between the cornea and a posterior surface of the soft contact lens is when worn on the eye.

In some embodiments, the vaulted portion is configured to form a free volume between the vaulted portion and the cornea when worn on the eye.

In some embodiments, the free volume is configured to be filled with a fluid to form a tear lens over the cornea when worn on the eye.

In some embodiments, the tear lens provides a correction to the ocular refractive error (e.g., astigmatism) of the eye.

In some embodiments, the vaulted portion is configured to correct the ocular refractive error without respect to a rotational orientation.

In some embodiments, the vaulted portion provides at least a portion of a cylindrical power correction.

In some embodiments, the vaulted portion provides a correction of a range of about −4 D to about +4 D.

In some embodiments, the vaulted portion provides at least about 10%, 20%, 30%, 40%, 50%, 60%, 70%, 80%, or 90% of a total power correction.

In some embodiments, the vaulted portion provides at least a portion of a cylindrical power correction.

In some embodiments, the vaulted portion provides at least about 10%, 20%, 30%, 40%, 50%, 60%, 70%, 80%, or 90% of total cylindrical power correction.

In some embodiments, the vaulted portion provides a first part of a total power correction and the specialty features provide a second part of the total power correction.

In some embodiments, the vaulted portion provides a first part of a total cylinder power correction and the specialty features provide a second part of the total cylinder power correction.

In some embodiments, the vaulted portion provides a correction to the ocular refractive error in combination with the tear lens that forms when the soft contact lens is worn on the eye.

In some embodiments, the tear lens provides a third part of the total power correction.

In some embodiments, the tear lens provides at least about 10%, 20%, 30%, 40%, 50%, 60%, 70%, 80%, or 90% of total cylindrical power correction.

In some embodiments, the soft contact lens comprises a fenestration.

In some embodiments, the fenestration fluidically connects a tear film to the lenticular volume when worn on the eye.

In some embodiments, the soft contact lens comprises a groove.

In some embodiments, the groove fluidically connects the fenestration to the lenticular volume when worn on the eye.

In some embodiments, a peripheral portion of the soft contacts lens is configured to conform to a surface of the eye when worn on the eye.

In some embodiments, the vaulted portion and the peripheral portion have the same modulus.

In an aspect of the present disclosure is a method of correcting an ocular refractive error of an eye using a soft contact lens as disclosed herein.

In an aspect of the present disclosure is a method of preparing a soft contact lens for correcting an ocular refractive error of an eye, the method comprising forming a fenestration through anterior surface to a posterior surface of the soft contact lens.

In some embodiments, a wall forming the fenestration has a conical shape.

In some embodiments, a wall forming the fenestration has a rounded shape.

In some embodiments, the fenestration is formed such that an opening of the fenestration to the anterior surface has a wider diameter than an opening of the fenestration to the posterior surface.

In some embodiments, the wider diameter of the opening of the fenestration to the anterior surface allows for improved fluid flow than when the opening of the fenestration to the anterior surface has a narrower diameter.

In some embodiments, the method further comprises forming a groove.

In some embodiments, the groove is on a posterior surface of the masking lens.

In some embodiments, the groove is formed such that the groove has a rounded surface.

In some embodiments, the groove has a wider base on the posterior surface than a cross-section closer to the anterior surface of the lens.

In some embodiments, the groove is formed by a mold.

In some embodiments, the fenestration is formed by a mold.

In some embodiments, the surface is coated.

In some embodiments, the coating improves lubrication of the lens.

In some embodiments, the improved lubrication improves wearer comfort.

In some embodiments, the coating has a thickness sufficient to smooth over the edges of a fenestration or a groove.

In some embodiments, the thickness is about 1 um to about 5 um.

In an aspect of the present disclosure is a method of preparing a soft contact lens for correcting an ocular refractive error of an eye, the method comprising forming the soft contact lens comprising an inner portion and a peripheral portion, wherein the inner portion has a material property different from a material property of the peripheral portion.

In some embodiments, the material property of the inner portion is higher than the material property of the peripheral portion.

In some embodiments, the material property of the inner portion is imparted by additional curing, polymerizing, cross-linking, or a combination thereof to the inner portion than the peripheral portion.

In some embodiments, the inner portion has a higher cross-link density than the peripheral portion.

In some embodiments, the material property of the inner portion and the material property of the peripheral portion comprise rigidity, elasticity, tensile modulus, or compressive modulus.

In some embodiments, the inner portion is formed by curing, polymerizing, cross-linking, or a combination thereof.

In some embodiments, the curing comprises applying heat, a UV light, an electromagnetic energy, or moisture, or a combination thereof.

In some embodiments, the inner portion has a cross-linking initiator during formation.

In some embodiments, the cross-linking initiator is activatable by heat, a UV light, an electromagnetic energy, or moisture, or a combination thereof.

In some embodiments, the method comprises covering a portion of the lens such that a portion receives less heat, a UV light, an electromagnetic energy, or moisture, or a combination thereof than an uncovered portion.

In some embodiments, the method comprises covering a portion of the lens such that an uncovered portion is selectively cured, polymerized, or cross-linked.

In some embodiments, the masking lens comprises a hydrogel.

In some embodiments, the masking lens comprise a silicone hydrogel. In some embodiments, the surface is coated.

In some embodiments, the coating improves lubrication of the lens.

In some embodiments, the improved lubrication improves wearer comfort.

In some embodiments, the coating has a thickness sufficient to smooth over the edges of a fenestration or a groove.

In some embodiments, the thickness is about 1 μm to about 5 μm.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 illustrates a cross sectional view of a soft contact lens comprising a fenestration and a groove.

FIG. 2 illustrates a cross sectional view of a soft contact lens comprising a fenestration.

FIG. 3 illustrates a cross sectional view of a soft contact lens comprising a groove.

FIG. 4 illustrates a cross sectional view of a soft contact lens comprising a fenestration.

FIG. 5 illustrates a cross-sectional view of a mold design for producing a soft contact lens having a fenestration.

FIG. 6 illustrates a cross sectional view of a soft contact lens comprising a fenestration.

FIG. 7 illustrates a cross-sectional view of a mold design for producing a soft contact lens having a fenestration.

FIGS. 8A-8B illustrate a top view and a cross-sectional view of a toric lens with radial fenestrations.

FIGS. 9A-9B illustrate a top view and a cross-sectional view of a toric lens with circumferential grooves.

FIGS. 10A-10B illustrate a top view and a cross-sectional view of a multifocal lens with radial fenestrations.

FIGS. 11A-11B illustrate a top view and a cross-sectional view of a multifocal lens with circumferential grooves.

### DETAILED DESCRIPTION

For those having one or more refractive errors, specialized contact lenses may be needed to correct the one or more refractive errors. Due to the various fitting criteria to correct these refractive errors, a large variety of specialized contact lenses meeting these additional criteria may need to be manufactured and stored. In some cases, toric contact lenses for correcting astigmatism needs multiple different designs having different base curves and various features for each power step and each angle step between the two meridians (e.g., steep and flat meridians) to cover a range of astigmatism subjects may have. Often, the fitting of these specialized contact lenses may be more time-consuming than fitting of conventional contact lenses, at least in part due to the large number of lens options. Further, current contact lenses may not be suitable to correct one or more refractive errors to a high degree of satisfaction due to a complexity of the refractive errors. In some cases, the subject wearing a contact lens may experience dizziness or blurred correction due to the correction needed. There is a need for contact lenses that can correct one or more refractive errors as well as providing solutions to reduce the number of different contact lenses needed to be manufactured and stored.

Provided herein are specialized soft contact lenses for correcting an ocular refractive error of an eye comprising at least a vaulted portion and a specialty feature. Usually, the vaulted portion may form a tear film lens in the lenticular volume formed between the vaulted portion and the cornea when the lens is worn on the eye. In some cases, the tear film lens formed by the vaulted portion provides at least a part of the correction of the ocular refractive error. In some cases, the tear film lens formed by the vaulted portion provides at least a part of correction of astigmatism. Often, the specialty feature comprises a toric feature, or a multifocal feature, or a combination thereof. In some cases, the toric feature comprises a prism-ballast, a peri-ballast, a back toric element, or a thin-zone design, or a combination thereof. In some cases, the multifocal feature comprises a bifocal feature, a trifocal feature, or a progressive feature, or a combination thereof. In some cases, the multifocal feature comprises an aspheric multifocal feature, a concentric multifocal feature, or a segmented multifocal feature, or a combination thereof. In some cases, the specialty feature comprises a power correction feature.

The current disclosure describes various aspects of a soft contact lenses for masking corneal astigmatism, corneal irregularities, coma, and any optical aberrations originating from the corneal geometrical surface. For the purposes of this disclosure, such lenses may be defined as a masking lenses. More particularly, this disclosure provides methods for manufacturing, optical design, material, coating and design of masking lenses.

### Contact Lens

Provided herein is a soft contact lens for correcting an ocular refractive error of an eye, the soft contact lens comprising a vaulted portion and a specialty feature. In some embodiments, a posterior surface of the soft contact lens comprises the vaulted portion.

In some embodiments, the vaulted portion is across the thickness of the contact lens. In some embodiments, the posterior surface and anterior surfaces are vaulted. In some embodiments, the specialty feature is configured such that there is a change in the thickness of the contact lens as compared to a contact lens without the specialty feature. In some embodiments, the specialty feature involves a change that belongs in the thickness of the contact lens body. In some embodiments, the location of the vaulted portion in a rotated lens may change in relation to another lens feature. In some embodiments, an anterior surface of the soft contact lens comprises the specialty feature. In some embodiments, a posterior surface of the soft contact lens comprises the specialty feature.

In some embodiments, the specialty feature is a different layer than the vaulted portion. In some embodiments, the specialty feature is on a different surface than the vaulted portion.

The specialty feature and the vaulted portion may be arranged in various formations on the contact lens. In some embodiments, a portion of the specialty feature and a portion of the vaulted portion overlaps in an optical portion of the soft contact lens. In some embodiments, the specialty feature and the vaulted portion do not overlap. In some embodiments, the vaulted portion and the specialty feature are aligned in a specific orientation. In some embodiments, the vaulted portion and the specialty feature are aligned in a manner configured for maximum optical power correction.

In some embodiments, the vaulted portion and the specialty feature do not require alignment in a specific orientation. In some embodiments, the vaulted portion and the specialty feature sufficiently correct optical power regardless of alignment.

In some embodiments, the specialty feature comprises a multifocal, a toric, an aspheric, a myopia-correcting, or an ortho-k lens. In some embodiments, the specialty feature comprises a multifocal lens. In some embodiments, the specialty feature comprises a toric lens. In some embodiments, the specialty feature comprises an aspheric lens. In some embodiments, the specialty feature comprises a myopia-correcting lens. In some embodiments, the specialty feature comprises an ortho-k lens. In some embodiments, the specialty feature comprises a single vision contact lens.

In some embodiments, the specialty feature corrects for a different optical aberration than the vaulted portion does. In some embodiments, the specialty feature corrects for presbyopia and the vaulted portion corrects for astigmatism.

In some embodiments, the specialty feature corrects for the same optical aberration as the vaulted portion. In some embodiments, the specialty feature and the vaulted portion both correct for astigmatism. In some embodiments, the vaulted portion corrects for a first amount of optical power and the specialty portion corrects for a second amount of optical power.

In some embodiments, the optical aberration comprises a lower order aberration or a higher order aberration. In some embodiments, the lower order aberration comprises astigmatism, myopia, or hyperopia. In some embodiments, the higher order aberration comprises spherical aberration, coma, or trefoil. In some embodiments, the higher order aberration is unable to be corrected by a cylinder correction or a spherical correction.

In some embodiments, the contact lens comprises a uniform spherical anterior surface. In some embodiments, the contact lens comprises a uniform spherical posterior surface. In some embodiments, the contact lens comprises one or more fenestrations. In some embodiments, the contact lens comprises one or more grooves. In some embodiments, the contact lens comprises a fenestration and a groove.

In some embodiments, the soft contact lens comprises a continuous body (e.g., unibody). In some embodiments, the soft contact lens comprises one discrete body. In some embodiments, the soft contact lens comprises a contiguous body. In some embodiments, the vaulted portion and the specialty feature are molded as one discrete body. In some embodiments, the vaulted portion and the specialty feature are molded in one step. In some embodiments, the soft contact lens has a single compressive modulus. In some embodiments, the soft contact lens has a single tensile modulus.

In some embodiments, the soft contact lens is made of a single material. In some embodiments, the entire soft contact lens is made of a single material having a same tensile modulus throughout the material. In some embodiments, the single material comprises a hydrogel. In some embodiments, the single material comprises a silicone. In some embodiments, the single material comprises a silicone hydrogel.

In some embodiments, the soft contact lens is made of one or more materials.

In some embodiments, soft contact lenses are made of polymers or hydrogels whose chemical properties are defined by their chemical composition. In some embodiments, the soft contact lenses are made of a single material. In some embodiments, the soft contact lens is made of a soft material. In some embodiments, the soft contact lenses is made of a single material that has substantially uniform mechanical properties throughout. In some embodiments, the soft contact lens is made of a single polymeric material. In some embodiments, the soft contact lenses comprises a hydrogel, silicone hydrogel, or silicone. In some embodiments, the soft contact lens is made from a single material comprising diacetone acrylamide, N,N-dimethylacrylamide, 2-hydroxyethyl methacrylate, methacrylic acid, methyl methacrylate, N-carboxyl vinyl ester, N-vinyl pyrrolidone, poly[dimethylsiloxyl] di[silybutanol] bis[vinyl carbamate], phosphorylcholine, tris-(trimethylsiloxysilyl) propylvinyl carbamate, tris-(hydroxylmethyl) aminomethane, siloxane, or polyvinylpyrrolidone. In some embodiments, the soft contact lens comprises diacetone acrylamide. In some embodiments, the soft contact lens comprises N,N-dimethylacrylamide. In some embodiments, the soft contact lens comprises 2-hydroxyethyl methacrylate. In some embodiments, the soft contact lens comprises methacrylic acid. In some embodiments, the soft contact lens comprises methyl methacrylate. In some embodiments, the soft contact lens comprises N-carboxyl vinyl ester. In some embodiments, the soft contact lens comprises N-vinyl pyrrolidone. In some embodiments, the soft contact lens comprises poly[dimethylsiloxyl] di[silybutanol] bis[vinyl carbamate]. In some embodiments, the soft contact lens comprises phosphorylcholine. In some embodiments, the soft contact lens comprises tris-(trimethylsiloxysilyl) propylvinyl carbamate. In some embodiments, the soft contact lens comprises tris-(hydroxylmethyl) aminomethane. In some embodiments, the soft contact lens comprises siloxane. In some embodiments, the soft contact lens comprises polyvinylpyrrolidone. In some embodiments, the soft contact lens comprises a hydrogel. In some embodiments, the soft contact lens comprises a silicone hydrogel.

In some embodiments, the lens material comprises silicone elastomer having optically clear silicate disposed therein. In some embodiments, the material comprises any suitable water content. In some embodiments, the material has a water content of at most about 20%, at most 15%, at most 10%, at most 9%, at most 8%, at most 7%, at most 6%, at most 5%, at most 4%, at most 3%, at most 2%, at most 1%, or less. The material may have a water content of at least about 1%, at least 2%, at least 3%, at least 4%, at least 5%, at least 6%, at least 7%, at least 8%, at least 9%, at least 10%, at least 15%, at least 20%, at least 30%, at least 50%, at least 60%, at least 70%, at least 80%, at least 90%, at least 95%, at least 99% or more. In some embodiments, the material has a water content that is within a range defined by any two of the preceding values. In some embodiments, the material contains at most about 90% water content. In some embodiments, the material contains at most about 10% water content. In some embodiments, the material contains at most about 5% water content.

In some embodiments, the lens comprises have any suitable oxygen permeability (Dk). In some embodiments, the lens has a high oxygen permeability (Dk), which in some embodiments may exceed 150. In some embodiments, the oxygen permeability of the lens is about 30 to 400 Dk. In some embodiments, the silicone lens comprising silicate is treated to provide a wettable surface.

In some embodiments, the chemistry of the surface of the lens is modified through the application of coatings or other suitable means known in the art. In some embodiments, the surface of the lens may be modified by at least one of chemical treatment, chemical vapor deposition, chemical etching, gas plasma, or laser treatment.

In some embodiments, soft contact lenses are made of elastomeric or partially elastomeric materials. Such elasticity means that any deformation from a neutral configuration (i.e., “as-manufactured” shape) is caused by an external stress such as blinking. Such external stresses are energetically stored within the deformed lens and causes the lens to bias towards the neutral configuration when the external stresses are reduced or removed. In some embodiments, for a soft, spherical contact lens on an astigmatic cornea, the act of conforming the contact lens to the non-spherically symmetric (i.e., non-axially symmetric) surface (of the cornea) generates a small amount of potential energy stored within the lens. In some embodiments, the stored energy causes the lens to partially vault from the cornea in a process that returns the contact lens closer to its lowest energy configuration (i.e., neutral configuration or “as-manufacture” shape). In some embodiments, as the contact lens partially vaults, fluid flows into the space formed between the corneal surface and the posterior surface of the lens structurally supporting the contact lens. In some embodiments, the greater the potential energy stored within the lens body, the easier it is for the lens body to deviate from a deformed configuration (i.e., return to a neutral configuration) and a fluid to flow between the posterior surface of the lens and the corneal surface.

In some embodiments, the act of blinking causes the contact lens to fully conform to the non-spherically symmetric cornea. In some embodiments, the fully conformed contact lens retains a deformed shape (i.e., deformed from a neutral configuration) because of adhesive energy between the surface of the lens and the corneal surface (if, for example, the adhesive energy is greater than the stored potential energy in the fully conformed contact lens).

In some embodiments, the contact lenses of the present disclosure further comprise at least one fenestration to facilitate fluid flow. In some embodiments, the lens includes at least one fenestration and at least one groove acting as a fluid pathway between a fluid source and a lenticular volume formed between a posterior surface of the lens and a corneal surface of the eye. For example, the at least one fenestration may act as a fluid pathway from the tear meniscus to the lenticular volume. In some embodiments, the at least one fenestration further reduces the resistance of flow of the fluid, allowing the fluid to flow more quickly into the lenticular volume. In some embodiments, the at least one fenestration is a plurality of fenestrations. In some embodiments, the fenestrations are distributed radially, circumferentially, or a combination thereof.

In some embodiments, the contact lenses of the present disclosure further comprise at least one groove to facilitate fluid flow. In some embodiments, the lens includes at least one fenestration and at least one groove acting as a fluid pathway between a fluid source and a lenticular volume formed between a posterior surface of the lens and a corneal surface of the eye. For example, the at least one grove may act as a fluid pathway from the tear meniscus to the fenestrations or lenticular volume. In some embodiments, the at least one groove further reduces the resistance of flow of the fluid, allowing the fluid to flow more quickly into the lenticular volume. In some embodiments, the at least one groove is a plurality of grooves. In some embodiments, the grooves are distributed radially, circumferentially, or a combination thereof.

In some embodiments, the elastic modulus of the lens, thickness of the lens, and/or degree of deformation influences how much energy is stored in the lens when the lens conforms to the corneal surface. For example, a relatively thick lens can store greater energy when conformed to the corneal surface. In some embodiments, the degree of deformation is determined by measuring the volumetric difference between the lens's neutral configuration (i.e., “as-manufactured” shape) and the deformed configuration.

In some embodiments, the elastic modulus of the contact lens may be at least about 0.1 megapascals (MPa), at least 0.2 MPa, at least 0.3 MPa, at least 0.4 MPa, at least 0.5 MPa, at least 0.6 MPa, at least 0.7 MPa, at least 0.8 MPa, at least 0.9 MPa, at least 1 MPa, at least 1.1 MPa, at least 1.2 MPa, at least 1.3 MPa, at least 1.4 MPa, at least 1.5 MPa, at least 1.6 MPa, at least 1.7 MPa, at least 1.8 MPa, at least 1.9 MPa, at least 2 MPa, at least 2.1 MPa, at least 2.2 MPa, at least 2.3 MPa, at least 2.4 MPa, at least 2.5 MPa, at least 2.6 MPa, at least 2.7 MPa, at least 2.8 MPa, at least 2.9 MPa, at least 3 MPa, at least 4 MPa, at least 5 MPa, at least 6 MPa, at least 7 MPa, at least 8 MPa, at least 9 MPa, at least 10 MPa, or more. In some embodiments, the elastic modulus of the contact lens may be at most about 10 MPa, at most 9 MPa, at most 8 MPa, at most 7 MPa, at most 6 MPa, at most 5 MPa, at most 4 MPa, at most 3 MPa, at most 2.9 MPa, at most 2.8 MPa, at most 2.7 MPa, at most 2.6 MPa, at most 2.5 MPa, at most 2.4 MPa, at most 2.3 MPa, at most 2.2 MPa, at most 2.1 MPa, at most 2 MPa, at most 1.9 MPa, at most 1.8 MPa, at most 1.7 MPa, at most 1.6 MPa, at most 1.5 MPa, at most 1.4 MPa, at most 1.3 MPa, at most 1.2 MPa, at most 1.1 MPa, at most 1 MPa, at most 0.9 MPa, at most 0.8 MPa, at most 0.7 MPa, at most 0.6 MPa, at most 0.5 MPa, at most 0.4 MPa, at most 0.3 MPa, at most 0.2 MPa, at most 0.1 MPa, or less. The elastic modulus of the contact lens may be within a range defined by any two of the preceding values. For instance, the elastic modulus of the contact lens may be from about 0.1 MPa to about 10 MPa. For example, the elastic modulus of the contact lens may be from about 0.1 MPa to about 4 MPa.

In some embodiments, the mechanical properties of any feature of the lenses described herein, depend on both the geometry of feature and the material of the feature (including the material's properties). Aspects of the mechanical properties of the lens body are described using the mechanical model of a simply supported circular plate. In this model, the deflection of the simply supported plate (“D”) is proportional to the Young's modulus (“E”) multiplied by the thickness (“t”) cubed or D=Et3/(12*(1−v2). Other parameters of the model (such as, radius of plate, uniform loading, and Poisson's ratio (“v”)) may be treated as constants when comparing various modulus and thickness configurations. When comparing the lenses of the present disclosure, the current description utilizes unit's customary to contact lens designers of Megapascals (“MPa”) for Young's Modulus and micrometers (“um”) for thickness.

In some embodiments, the thickness of the contact lens may be at least about 40 μm, at least 50 μm, at least 60 μm, at least 70 μm, at least 80 μm, at least 90 μm, at least 100 microns, 150 μm, at least 200 μm, at least 250 μm, at least 300 μm, at least 350 μm, at least 400 μm, at least 450 μm, at least 500 μm, at least 550 μm, at least 600 μm, at least 650 μm, at least 700 μm, at least 750 μm, or any values therebetween. In some embodiments, the thickness of the contact lens may be at most about 800 μm, at most 750 μm, at most 700 μm, at most 650 μm, at most 600 μm, at most 550 μm, at most 500 μm, at most 450 μm, at most 400 μm, at most 350 μm, at most 300 μm, at most 250 μm, at most 200 μm, at most 150 μm, at most 100 μm, at most 90 μm, at most 80 μm, at most 70 μm, at most 60 μm, at most 50 μm, at most 40 μm, or any values therebetween. The thickness of the contact lens may be within a range defined by any two of the preceding values. For instance, the thickness of the contact lens may be from about 40 μm to about 600 μm. For example, the thickness of the contact lens may be from about 300 μm to about 600 μm. In some embodiments, the thickness of the contact lens measured by a distance from the two surfaces in a cross-section of the contact lens.

### Multifocal Feature

In some embodiments, the specialty feature comprises a multifocal feature. In some embodiments, the multifocal feature comprises a bifocal feature, a trifocal feature, or a progressive feature. In some embodiments, the multifocal feature comprises an aspheric multifocal feature. In some embodiments, the multifocal feature comprises a concentric multifocal feature. In some embodiments, the multifocal feature comprises a segmented multifocal feature. In some embodiments, the multifocal feature comprises a spherical feature and an aspherical feature. In some embodiments, the multifocal feature comprises one, two, or three optical powers. In some embodiments, the multifocal feature comprises at least two optical powers. The spherical surface of the central area can provide a single dioptric power, and the aspherical surface can provide a transition of optical powers to provide a gradual correction of intermediate and near vision. The transition provided by the aspherical surface can be achieved by gradually decreasing the radii in the annular area from a region adjacent the perimeter of the central area to the outer edge of the annular area. It can be appreciated that because the radius of curvature at the inner perimeter of the annular area is almost equal to the radius of curvature of the central area, a sharp transition between the central area and the annular area may not be noticeable. In addition, because of the change in curvature in the annular area, the annular area represents a progressive aspheric region of the lens.

In some embodiments, the soft contact lens may comprise a contact lens that slows the progression of myopia. Such combination may be a soft contact lens, with a multifocal optic design or an aspheric optic design. In both cases, the soft contact lens enables some defocusing in the peripheral vision to control the myopia development.

In some embodiments, the multifocal feature is configured to correct presbyopia. In some embodiments, the multifocal feature is configured to correct myopia. In some embodiments, the multifocal feature is configured to correct myopia and presbyopia. In some embodiments, the multifocal feature is configured to correct astigmatism.

In some embodiments, the multifocal feature provides a correction of at least about −6 diopter (D), −5.75 D, −5.5 D, −5.25 D, −5 D, −4.75 D, −4.5 D, −4.25 D, −4 D, −3.75 D, −3.5 D, −3.25 D, −3 D, −2.75D, −2.5 D, −2.25 D, −2 D, −1.75D, −1.5 D, −1.25D, −1 D, −0.75 D, −0.5 D, −0.25 D, +0.25 D, +0.5 D, +0.75 D, +1 D, +1.25 D, +1.5 D, +1.75 D, +2 D, +2.25 D, +2.5 D, +2.75 D, +3 D, +3.25 D, +3.5 D, +4 D, +4.25 D, +4.5 D, +4.75 D, +5 D, +5.25 D, +5.5 D, +5.75 D, or +6 D. In some embodiments, the multifocal feature provides a correction of up to about +5 D, up to +4.75 D, up to +4.5 D, up to +4.25 D, up to +4 D, up to +3.75 D, up to +3.5 D, up to +3.25 D, up to +3 D, up to +2.75 D, up to +2.5 D, up to +2.25 D, up to +2 D, up to +1.75 D, up to +1.5 D, up to +1 D, up to+0.75 D, up to +0.5 D, or less. In some embodiments, the multifocal feature provides a correction of up to about −5 D, up to −4.75 D, up to −4.5 D, up to −4.25 D, up to −4 D, up to −3.75 D, up to −3.5 D, up to −3.25 D, up to −3 D, up to −2.75 D, up to −2.5 D, up to −2.25 D, up to −2 D, up to −1.75 D, up to −1.5 D, up to −1 D, up to −0.75 D, up to −0.5 D, or less. In some embodiments, the correction is in the spherical power. In some embodiments, the correction is in the cylindrical power.

In some embodiments, the multifocal feature provides at least about 10%, 20%, 30%, 40%, 50%, 60%, 70%, 80%, or 90% of total power correction. In some embodiments, the multifocal feature provides at most about 99%, 95%, 90%, 80%, 70%, 60%, 50%, 40%, 30%, 20%, or less of a total power correction.

In some embodiments, the multifocal feature is on an anterior portion of the soft contact lens. In some embodiments, the multifocal feature is on a posterior portion of the soft contact lens.

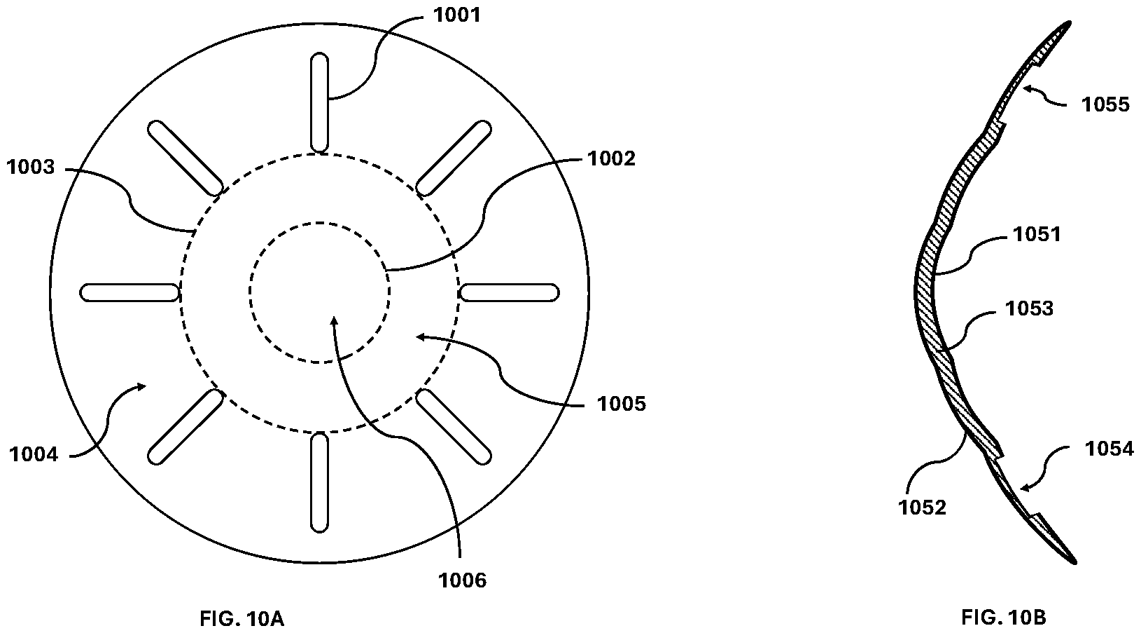

Provided herein are lenses which may be used to correct an optical aberration in an eye of a subject. A longitudinal view of a soft contact lens comprising a multifocal element with radial fenestrations is schematically illustrated in FIG. 10A. In some embodiments, a discontinuity 1001 can be a fenestration or a groove or a combination thereof. In some embodiments, the lens comprises one or more zones of curvature 1004, 1005, and 1006. A side sectional view of the lens is shown in FIG. 10B. In some embodiments, the lens 1053 comprises an anterior surface 1052 and a posterior surface 1051. In some embodiments, the lens 1053 comprises one or more divots 1054, 1055 from one or more grooves or fenestrations.

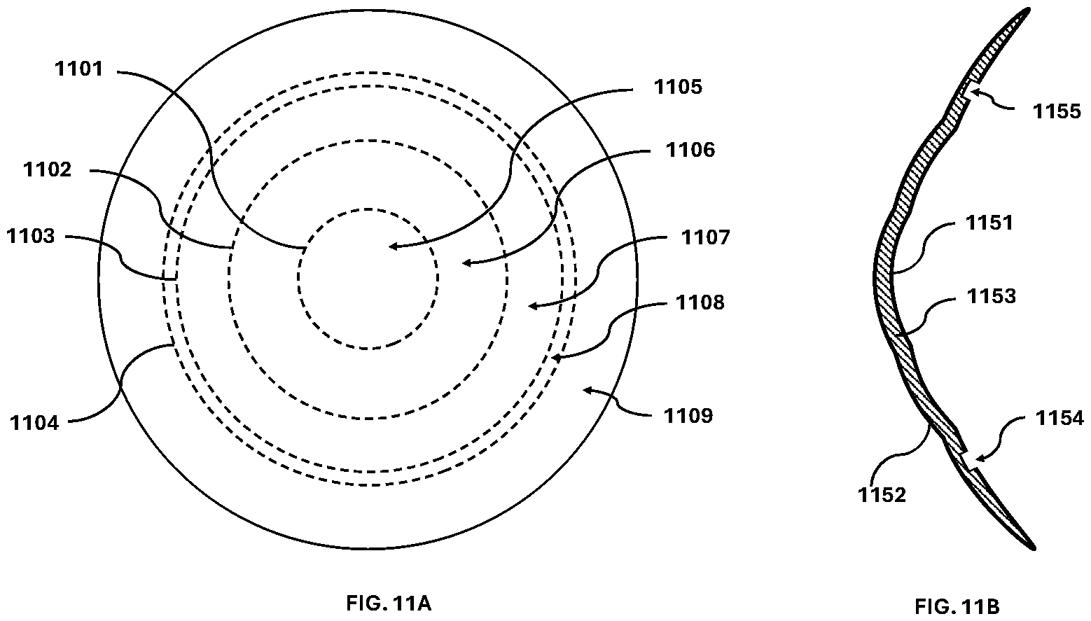

Provided herein are lenses which may be used to correct an optical aberration in an eye of a subject. A longitudinal view of a soft contact lens comprising a multifocal element with circumferential grooves is schematically illustrated in FIG. 11A. In some embodiments, a discontinuity 1101 can be a groove or a fenestration. In some embodiments, the lens comprises one or more zones of curvature 1105, 1106, 1107, 1108, and 1009. A side sectional view of the lens is shown in FIG. 11B. In some embodiments, the lens 1153 comprises an anterior surface 1152 and a posterior surface 1151. In some embodiments, the lens 1153 comprises one or more divots 1154, 1155 from one or more grooves or fenestrations.

### Toric Feature

In some embodiments, the specialty feature comprises a toric feature. In some embodiments, the toric feature comprises a prism-ballast, a peri-ballast, a back toric element, or a thin-zone design, or a combination thereof. Such a toric element can be used for aligning at least one fenestration with the tear meniscus. In some embodiments, a toric element does not require customization related to the orientation of the corneal topography and/or astigmatism.

In some embodiments, the toric element comprises a stabilizer or a weight. In some embodiments, the toric element is oriented downward (e.g., 6 o′clock orientation and/or towards the lower tear meniscus when worn on the eye) with fixed orientation in the downward orientation (e.g., no rotation of the lens). In some embodiments, the toric element is oriented upwards (e.g., 12 o′clock orientation and/or towards the upper tear meniscus).

In some embodiments, the toric feature is located in a peripheral portion of the soft contact lens. In some embodiments, the toric feature provides a cylindrical correction.

In some embodiments, the toric feature provides a correction of at least about −6 diopter (D), −5.75 D, −5.5 D, −5.25 D, −5 D, −4.75 D, −4.5 D, −4.25 D, −4 D, −3.75 D, −3.5 D, −3.25 D, −3 D, −2.75D, −2.5 D, −2.25 D, −2 D, −1.75D, −1.5 D, −1.25D, −1 D, −0.75 D, −0.5 D, −0.25 D, +0.25 D, +0.5 D, +0.75 D, +1 D, +1.25 D, +1.5 D, +1.75 D, +2 D, +2.25 D, +2.5 D, +2.75 D, +3 D, +3.25 D, +3.5 D, +4 D, +4.25 D, +4.5 D, +4.75 D, +5 D, +5.25 D, +5.5 D, +5.75 D, or +6 D. In some embodiments, the toric feature provides a correction of about up to +5 D, up to +4.75 D, up to +4.5 D, up to +4.25 D, up to +4 D, up to +3.75 D, up to +3.5 D, up to +3.25 D, up to +3 D, up to +2.75 D, up to +2.5 D, up to +2.25 D, up to +2 D, up to +1.75 D, up to +1.5 D, up to +1 D, up to +0.75 D, up to +0.5 D, or less. In some embodiments, the toric feature provides a correction of up to about −5 D, up to −4.75 D, up to −4.5 D, up to −4.25 D, up to −4 D, up to −3.75 D, up to −3.5 D, up to −3.25 D, up to −3 D, up to −2.75 D, up to −2.5 D, up to −2.25 D, up to −2 D, up to −1.75 D, up to −1.5 D, up to −1 D, up to −0.75 D, up to −0.5 D, or less. In some embodiments, the correction is in the spherical power. In some embodiments, the correction is in the cylindrical power.

In some embodiments, the toric feature provides a correction of about at least +6 D, +5.75 D, at least+5.5 D, at least+5.25 D, at least +5 D, at least +4.75 D, at least +4.5 D, at least +4.25 D, at least +4 D, at least +3.75 D, at least +3.5 D, at least +3.25 D, at least +3 D, at least +2.75 D, at least +2.5 D, at least +2.25 D, at least +2 D, at least +1.75 D, at least +1.5 D, at least +1 D, at least +0.75 D, at least +0.5 D, or less. In some embodiments, the toric feature provides a correction of about at least −6 D, at least −5 D, at least −4.75 D, at least −4.5 D, at least −4.25 D, at least −4 D, at least −3.75 D, at least −3.5 D, at least −3.25 D, at least −3 D, at least −2.75 D, at least −2.5 D, at least −2.25 D, at least −2 D, at least −1.75 D, at least −1.5 D, at least −1 D, at least −0.75 D, at least −0.5 D, or less. In some embodiments, the correction is in the spherical power. In some embodiments, the correction is in the cylindrical power. In some embodiments, the toric feature is configured to mask an astigmatism that is within a range defined by any two of the preceding values.

In some embodiments, the toric feature provides at least about 10%, 20%, 30%, 40%, 50%, 60%, 70%, 80%, or 90% of total power correction. In some embodiments, the toric feature provides at most about 99%, 95%, 90%, 80%, 70%, 60%, 50%, 40%, 30%, 20%, or less of a total power correction. In some embodiments, the toric feature may correct (i.e., mask) an astigmatism by at least about 20%, at least 30%, at least 40%, at least 50%, at least 60%, at least 65%, at least 70%, at least 75%, at least 80%, at least 85%, at least 90%, at least 95%, at least 99%, at least or more. In some cases, the toric feature may mask an astigmatism by at most about 99%, 95%, 90%, 85%, 80%, 75%, 70%, 65%, 60%, 50%, 40%, 30%, 20%, or less. In some embodiments, correcting (i.e., mask) an astigmatism by a certain percentage refers to increasing the visual acuity as compared to that of a normal visual acuity (e.g., 6/6 or 20/20 vision).

In some embodiments, the toric feature provides at least a portion of a cylindrical power correction. In some embodiments, the toric feature provides at least about 10%, 20%, 30%, 40%, 50%, 60%, 70%, 80%, or 90% of total cylindrical power correction.

In some embodiments, the vaulted portion provides at least a portion of a cylindrical power correction. In some embodiments, the vaulted portion provides at least about 10%, 20%, 30%, 40%, 50%, 60%, 70%, 80%, or 90% of total cylindrical power correction.

In some embodiments, the vaulted portion provides a correction to the ocular refractive error in combination with the tear lens that forms when the soft contact lens is worn on the eye. In some embodiments, the tear lens formed in between the vaulted portion and the cornea when the contact lens is worn on the eye provides at least a portion of a cylindrical power correction. In some embodiments, the tear lens provides at least about 10%, 20%, 30%, 40%, 50%, 60%, 70%, 80%, or 90% of total cylindrical power correction.

In some embodiments, the vaulted portion provides a first part of a total cylinder power correction and the specialty features provide a second part of the total cylinder power correction. In some embodiments, the tear lens provides a third part of the total power correction.

In some embodiments, the soft contact lens may comprise a toric lens that corrects astigmatism. For example, in a subject with a cylinder of 2.25 D, assuming the contact lens for masking astigmatism masks 1.25 D of astigmatism and there is residual uncorrected astigmatism of 1 D. In such a case, there is advantage to utilizing the soft contact lens comprising a toric lens rather than providing a single toric lens of 2.25 D since fitting becomes substantially easier as fitting a toric lens of 1 D is easier than fitting a toric lens of 2.25 D since the latter is more sensitive to any axis misalignment.

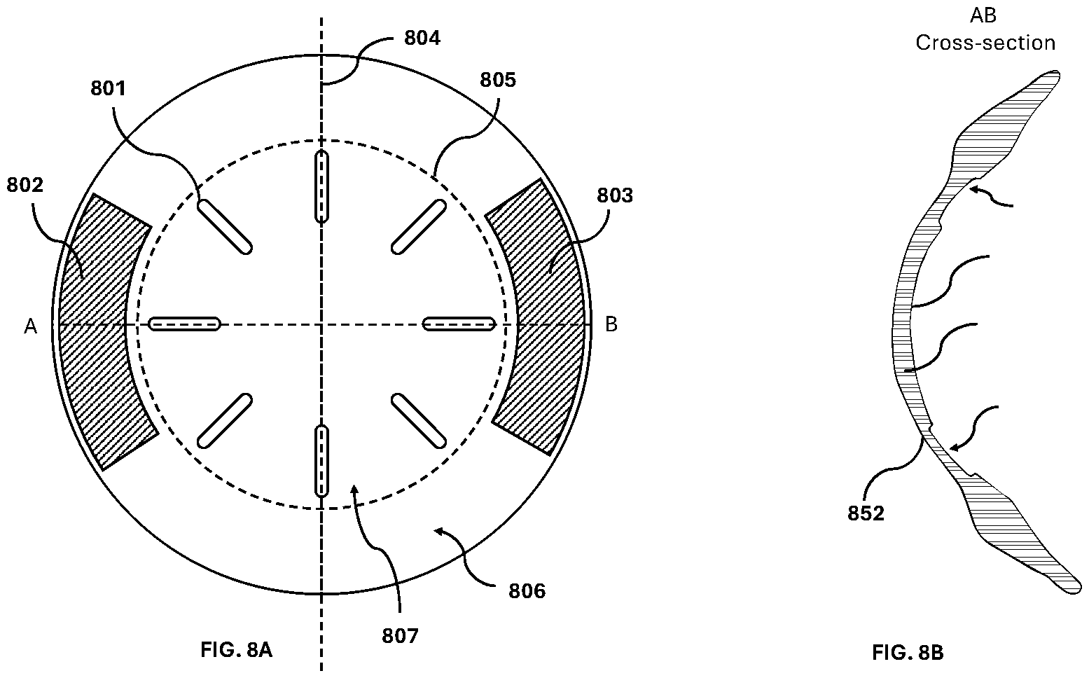

Provided herein are lenses which may be used to correct an astigmatism in an eye of a subject. A longitudinal view of a soft contact lens comprising a toric element with radial fenestrations is schematically illustrated in FIG. 8A. In some embodiments, a discontinuity 801 can be a fenestration or a groove. In some embodiments, a toric element 802, 803 can be a stabilizer or weight. In some embodiments, the lens comprises a groove 805. In some embodiments, the lens comprises an inner portion 807 and a peripheral portion 806. A side sectional view of the lens is shown in FIG. 8B. In some embodiments, the lens 853 comprises an anterior surface 852 and a posterior surface 851. In some embodiments, the lens 853 comprises one or more divots 854, 855 from one or more grooves or fenestrations.

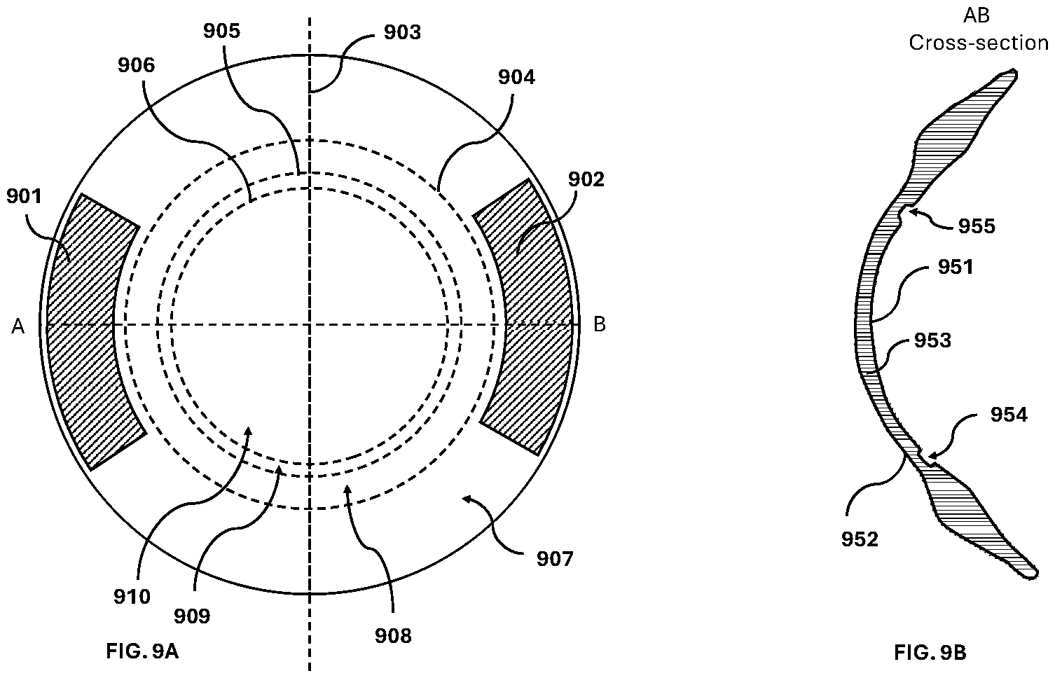

Provided herein are lenses which may be used to correct an astigmatism in an eye of a subject. A longitudinal view of a soft contact lens comprising a toric element with circumferential grooves is schematically illustrated in FIG. 9A. In some embodiments, a toric element 901, 902 can be a stabilizer or weight. In some embodiments, the lens comprises one or more grooves 904, 905, 906. In some embodiments, the lens comprises different zones of curvature 907, 908, 909, 910. A side sectional view of the lens is shown in FIG. 9B. In some embodiments, the lens 953 comprises an anterior surface 952 and a posterior surface 951. In some embodiments, the lens 953 comprises one or more divots 954, 955 from one or more grooves or fenestrations.

The soft contact lens as described herein provides several advantages over conventional toric lenses. In some cases, toric contact lenses for correcting astigmatism needs multiple different designs having different base curves and various features for each power step and each angle step between the two meridians (e.g., steep and flat meridians) to cover a range of astigmatism subjects may have. Further, a patient can suffer from residual astigmatism if their particular astigmatism axis does not fall squarely on a 5 or 10 degree step that are used in convention toric lenses. In some cases, toric contact lenses with this single axis approach result in higher manufacturing complexity, with additional features for stabilizing the rotation of the lens (e.g., prism ballast, dynamic stabilization elements), compared to traditional sphere-correcting contact lenses. In some cases, toric contact lenses with a single axis approach may need significantly more lenses in inventory (e.g., stock keeping unit or SKU) for fitting and/or sales. In addition, the fitting of these specialized contact lenses may be more time-consuming than fitting of conventional contact lenses. The toric contact lenses often require stabilization to position the correcting cylinder at the appropriate axis on the eye, which takes time and may cause temporary discomfort and/or blurred vision for the user. Because of these complexities, contact lenses described herein can provide a toric correction while not requiring manufacture and storage of many different lenses.

### Vaulting Portion

In some embodiments, the vaulted portion is configured to vault over a portion of a cornea. In some embodiments, the vaulted portion is configured to vault over substantially all of a cornea. In some embodiments, the vaulted portion is configured to vault over a steep meridian of a cornea and substantially conform to the flat meridian of the cornea. In some embodiments, a portion of the vaulted portion is in an optical portion of the soft contact lens. In some embodiments, substantially all of the vaulted portion is in an optical portion of the soft contact lens. In some embodiments, the vaulted portion is configured to be suspended above the cornea when worn on the eye. In some embodiments, the vaulted portion is configured to be suspended above the specialty feature of the soft contact lens. In some embodiments, the vaulted portion is configured to form a free volume between the cornea and a posterior surface of the soft contact lens is when worn on the eye. In some embodiments, the vaulted portion is configured to form a free volume between the vaulted portion and the cornea when worn on the eye. In some embodiments, the vaulted portion is configured to allow for a tear lens to form. In some embodiments, the free volume is configured to be filled with a fluid to form a tear lens over the cornea when worn on the eye. The soft contact lenses provided herein may have multiple sectors, the volume of the tear lens under each sector may be different, and the combination of each sector and tear lens portion directly posterior to its respective sector may provide different refractive power.

In some embodiments, the tear lens provides a correction to the ocular refractive error (e.g., astigmatism) of the eye. In some embodiments, the ocular refractive error of the eye is a first order aberration or spherical aberration. In some embodiments, the ocular refractive error of the eye is a second order aberration or cylindrical aberration. In some embodiments, the ocular refractive error is a third order aberration or coma.

In some embodiments, the vaulted portion is configured to correct the ocular refractive error without respect to a rotational orientation. In some embodiments, the vaulted portion is configured to mask astigmatism independently of rotational orientation.

In some embodiments, the vaulted portion provides a correction of at least about −6 diopter (D), −5.75 D, −5.5 D, −5.25 D, −5 D, −4.75 D, −4.5 D, −4.25 D, −4 D, −3.75 D, −3.5 D, −3.25 D, −3 D, −2.75D, −2.5 D, −2.25 D, −2 D, −1.75D, −1.5 D, −1.25D, −1 D, −0.75 D, −0.5 D, −0.25 D, +0.25 D, +0.5 D, +0.75 D, +1 D, +1.25 D, +1.5 D, +1.75 D, +2 D, +2.25 D, +2.5 D, +2.75 D, +3 D, +3.25 D, +3.5 D, +4 D, +4.25 D, +4.5 D, +4.75 D, +5 D, +5.25 D, +5.5 D, +5.75 D, or +6 D. In some embodiments, the toric feature provides a correction of about up to +5 D, up to +4.75 D, up to +4.5 D, up to +4.25 D, up to +4 D, up to +3.75 D, up to +3.5 D, up to +3.25 D, up to +3 D, up to +2.75 D, up to +2.5 D, up to +2.25 D, up to +2 D, up to +1.75 D, up to +1.5 D, up to +1 D, up to +0.75 D, up to +0.5 D, or less. In some embodiments, the toric feature provides a correction of up to about −5 D, up to −4.75 D, up to −4.5 D, up to −4.25 D, up to −4 D, up to −3.75 D, up to −3.5 D, up to −3.25 D, up to −3 D, up to −2.75 D, up to −2.5 D, up to −2.25 D, up to −2 D, up to −1.75 D, up to −1.5 D, up to −1 D, up to −0.75 D, up to −0.5 D, or less. In some embodiments, the toric feature provides a correction of about at least +5 D, at least +4.75 D, at least +4.5 D, at least +4.25 D, at least +4 D, at least +3.75 D, at least +3.5 D, at least +3.25 D, at least +3 D, at least +2.75 D, at least +2.5 D, at least +2.25 D, at least +2 D, at least +1.75 D, at least +1.5 D, at least +1 D, at least+0.75 D, at least +0.5 D, or less. In some embodiments, the toric feature provides a correction of at least about −5 D, at least −4.75 D, at least −4.5 D, at least −4.25 D, at least −4 D, at least −3.75 D, at least −3.5 D, at least −3.25 D, at least −3 D, at least −2.75 D, at least −2.5 D, at least −2.25 D, at least −2 D, at least −1.75 D, at least −1.5 D, at least −1 D, at least −0.75 D, at least −0.5 D, or less. In some embodiments, the correction is in the spherical power. In some embodiments, the correction is in the cylindrical power.

In some embodiments, the vaulted portion is configured to mask an astigmatism of an eye of a subject. In some embodiments, the vaulted portion is configured to mask an astigmatism that is within a range defined by any two of the preceding values.

In some embodiments, the vaulted portion is configured to correct for differences in corneal power between meridians of about −4 D to about +4 D. The vaulted portion may be configured to correct for differences in corneal power that is within a range defined by any two of the preceding values. In some embodiments, the difference in corneal power is within a range from about-6 D and about +6 D.

In some embodiments, the vaulted portion provides at least about 10%, 20%, 30%, 40%, 50%, 60%, 70%, 80%, or 90% of a total power correction. In some embodiments, the vaulted portion provides at most about 99%, 95%, 90%, 80%, 70%, 60%, 50%, 40%, 30%, 20%, or less of a total power correction. In some embodiments, the vaulted portion provides about 10% or more of a total power correction. In some embodiments, the vaulted portion provides about 20% or more of a total power correction. In some embodiments, the vaulted portion provides about 30% or more of a total power correction. In some embodiments, the vaulted portion provides about 40% or more of a total power correction. In some embodiments, the vaulted portion provides about 50% or more of a total power correction. In some embodiments, the vaulted portion provides about 60% or more of a total power correction. In some embodiments, the vaulted portion provides about 70% or more of a total power correction. In some embodiments, the vaulted portion provides about 80% or more of a total power correction. In some embodiments, the vaulted portion provides about 90% or more of a total power correction.

In some embodiments, the vaulted portion may correct, also referred herein as mask, an astigmatism. In some embodiments, the vaulted portion may correct an astigmatism. In some embodiments, the vaulted portion may correct an astigmatism by at least about 20%, at least 30%, at least 40%, at least 50%, at least 60%, at least 65%, at least 70%, at least 75%, at least 80%, at least 85%, at least 90%, at least 95%, at least 99%, at least or more. In some embodiments, the vaulted portion may correct an astigmatism by about 20% or more. In some embodiments, the vaulted portion may correct an astigmatism by about 25% or more. In some embodiments, the vaulted portion may correct an astigmatism by about 90% or more. In some embodiments, the vaulted portion may correct an astigmatism by about 95% or more. In some cases, the vaulted portion may mask an astigmatism by at most about 99%, 95%, 90%, 85%, 80%, 75%, 70%, 65%, 60%, 50%, 40%, 30%, 20%, or less. In some embodiments, correcting (i.e., mask) an astigmatism by a certain percentage refers to increasing the visual acuity as compared to that of a normal visual acuity (e.g., 6/6 or 20/20 vision).

In some embodiments, the vaulted portion provides a first part of a total power correction and the specialty features provide a second part of the total power correction. In some embodiments, the vaulted portion provides about 10% or more of a total power correction and the specialty features provides about 90% or less of a total power correction. In some embodiments, the vaulted portion provides about 20% or more of a total power correction and the specialty features provides about 80% or less of a total power correction. In some embodiments, the vaulted portion provides about 30% or more of a total power correction and the specialty features provides about 70% or less of a total power correction. In some embodiments, the vaulted portion provides about 40% or more of a total power correction and the specialty features provides about 60% or less of a total power correction. In some embodiments, the vaulted portion provides about 50% or more of a total power correction and the specialty features provides about 50% or less of a total power correction. In some embodiments, the vaulted portion provides about 60% or more of a total power correction and the specialty features provides about 40% or less of a total power correction. In some embodiments, the vaulted portion provides about 70% or more of a total power correction and the specialty features provides about 30% or less of a total power correction. In some embodiments, the vaulted portion provides about 80% or more of a total power correction and the specialty features provides about 20% or less of a total power correction. In some embodiments, the vaulted portion provides about 90% or more of a total power correction and the specialty features provides about 10% or less of a total power correction. In some embodiments, the vaulted portion provides about 90% or less of a total power correction and the specialty features provides about 10% or more of a total power correction. In some embodiments, the vaulted portion provides about 80% or less of a total power correction and the specialty features provides about 20% or more of a total power correction. In some embodiments, the vaulted portion provides about 70% or less of a total power correction and the specialty features provides about 30% or more of a total power correction. In some embodiments, the vaulted portion provides about 60% or less of a total power correction and the specialty features provides about 40% or more of a total power correction. In some embodiments, the vaulted portion provides about 50% or less of a total power correction and the specialty features provides about 50% or more of a total power correction. In some embodiments, the vaulted portion provides about 40% or less of a total power correction and the specialty features provides about 60% or more of a total power correction. In some embodiments, the vaulted portion provides about 30% or less of a total power correction and the specialty features provides about 70% or more of a total power correction. In some embodiments, the vaulted portion provides about 20% or less of a total power correction and the specialty features provides about 80% or more of a total power correction. In some embodiments, the vaulted portion provides about 10% or less of a total power correction and the specialty features provides about 90% or more of a total power correction.

In some embodiments, the vaulted portion provides at least a portion of a cylindrical power correction. In some embodiments, the vaulted portion provides at least about 10%, 20%, 30%, 40%, 50%, 60%, 70%, 80%, or 90% of total cylindrical power correction. In some embodiments, the vaulted portion provides at most about 10%, 20%, 30%, 40%, 50%, 60%, 70%, 80%, or 90% of total cylindrical power correction. In some embodiments, the vaulted portion provides about 10%, 20%, 30%, 40%, 50%, 60%, 70%, 80%, or 90% of total cylindrical power correction.

In some embodiments, the vaulted portion provides a correction to the ocular refractive error in combination with the tear lens that forms when the soft contact lens is worn on the eye. In some embodiments, the tear lens formed in between the vaulted portion and the cornea when the contact lens is worn on the eye provides at least a portion of a cylindrical power correction. In some embodiments, the tear lens provides at least about 10%, 20%, 30%, 40%, 50%, 60%, 70%, 80%, or 90% of total cylindrical power correction. In some embodiments, the tear lens provides at most about 10%, 20%, 30%, 40%, 50%, 60%, 70%, 80%, or 90% of total cylindrical power correction. In some embodiments, the tear lens provides about 10%, 20%, 30%, 40%, 50%, 60%, 70%, 80%, or 90% of total cylindrical power correction.

In some embodiments, the vaulted portion provides a first part of a total cylinder power correction and the specialty features provide a second part of the total cylinder power correction. In some embodiments, the tear lens provides a third part of the total power correction.

### Fenestration and Groove

In some embodiments, the soft contact lens comprises a fenestration. In some embodiments, the fenestration fluidically connects a tear film to the lenticular volume when worn on the eye. In some embodiments, the soft contact lens comprises a groove. In some embodiments, the groove fluidically connects the fenestration to the lenticular volume when worn on the eye.

In some embodiments, the soft contact lens comprises at least one fenestration configured to promote a fluid, such as tear fluid or artificial tear fluid, to flow between the posterior surface of the contact lens and the corneal surface of an eye. In some embodiments, a conforming portion of the lens overlying relatively flat regions of the corneal surface supports a non-conforming, vaulting or vaulted portion of the lens allowing the fluid to fill a lenticular volume formed between the vaulted portions of lens and the steep regions of the cornea. By filling the lenticular volume between posterior surface of the lens and the steep regions of the cornea the lens may assume a shape that is closer to its neutral configuration (i.e., “as-manufactured” shape). In some embodiments, the vaulting of the contact lens facilitates filling of the lenticular volume with the fluid. In some embodiments, the at least one fenestration allows for increased oxygen transport through the lens to the cornea than for a contact lens with pores only. In some embodiments, the at least one fenestration allows for increased oxygen transport through the lens to the cornea than for a contact lens with no pores and/or no fenestrations.

In some embodiments, the at least one fenestration is connected to at least one groove overlying the tear meniscus at distance, intermediate, and near gazes. The at least one fenestration may be disposed radially or circumferentially on the contact lens. The at least one groove may be disposed radially or circumferentially on the contact lens. The at least one groove may be on the posterior surface of the contact lens. The at least one groove may be in fluid communication with the at least one fenestration. For example, the at least one groove may extend radially to the outer edge of the contact lens, in at least some cases from the at least one fenestration, such as to facilitate flow of tear fluid from adjacent the outer edge of the contact lens. Alternatively, or in combination, the at least one groove may extend from the at least one fenestration to a relatively more interior portion of the contact lens such as to facilitate flow of tear fluid to the lenticular volume(s) formed. The contact lens may have a plurality of grooves.

In some embodiments, the contact lens comprises a groove. In some embodiments, the groove is on a posterior surface of the masking lens. In some embodiments, the groove has a rounded surface. In some embodiments, the groove has a wider base on the posterior surface than a cross-section closer to the anterior surface of the lens. In some embodiments, the groove is formed by a mold. In some embodiments, the groove is formed by machining. In some embodiments, the groove is formed by chemical etching. In some embodiments, the groove is formed by laser etching. In some embodiments, the groove is formed by methods other than molding or etching as will be understood by one of ordinary skill in the art based on the teachings herein.

Factors that determine fluid flow across a contact lens include fluid availability, resistance of flow, lens material properties such as chemical properties (e.g., hydrophilicity or hydrophobicity), mechanical properties (e.g., modulus and elasticity), the geometrical shape of the lens, or a combination thereof.

The fenestration(s) may have any cross-sectional geometry including square, rectangular, circular, semi-circular, curved, triangular, or any other geometrical shape. In some embodiments, a fenestration has a square cross-sectional geometry. In some embodiments, a fenestration has a rectangular cross-sectional geometry. In some embodiments, a fenestration has a circular cross-sectional geometry. In some embodiments, a fenestration has a semi-circular cross-sectional geometry. In some embodiments, a fenestration has a curved cross-sectional geometry. In some embodiments, a fenestration has a triangular cross-sectional geometry.

In some embodiments, the at least one fenestration comprises a plurality of fenestrations. The plurality of fenestration may be evenly distributed around the center of the soft lens body. The plurality of fenestrations may be distributed non-evenly around the center of the soft lens body. The plurality of fenestrations can be distributed circumferentially. The plurality of fenestrations can be distributed radially. At least one fenestration of the plurality of fenestrations can be separated from an adjacent fenestration by a distance of about 1 mm. The plurality of fenestrations can be distributed along at least one meridian of the soft lens body. The radius defined by the plurality of fenestrations distributed radially can be from about 3 mm to about 8 mm. The plurality of fenestrations can be positioned from about 3 mm to about 9 mm from the center of the soft lens body. The plurality of fenestrations can be distributed along a length of the soft lens body. The length of the soft lens body may be a radius, diameter, or circumference of the lens body. The length of the soft lens body can be from about 4 mm to about 45 mm.

In some embodiments, the lens described herein comprises one or more fenestrations distributed radially from the center of the lens. In some embodiments, radially distributed fenestrations comprise one or more fenestrations extending from about the center of the lens towards the edge of the lens in a line. In some embodiments, a lens comprises one or more radial line of fenestrations. In some embodiments, a lens comprises one radial line of fenestrations. In some embodiments, a lens comprises two radial lines of fenestrations. In some embodiments, a lens comprises three radial lines of fenestrations. In some embodiments, a lens comprises four radial lines of fenestrations.

In some embodiments, a radial line of fenestrations comprises one or more fenestrations. In some embodiments, a radial line of fenestrations comprises one fenestration. In some embodiments, a radial line of fenestrations comprises two fenestrations. In some embodiments, a radial line of fenestrations comprises three fenestrations. In some embodiments, a radial line of fenestrations comprises four fenestrations. In some embodiments, a radial line of fenestrations comprises five fenestrations. In some embodiments, a radial line of fenestrations comprises at most five fenestrations. In some embodiments, a radial line of fenestrations comprises at most four fenestrations. In some embodiments, a radial line of fenestrations comprises at most three fenestrations. In some embodiments, a radial line of fenestrations comprises at most two fenestrations. In some embodiments, a radial line of fenestrations comprises at most one fenestration.

In some embodiments, a lens having two or more radial lines of fenestrations is configured such that an angle between two lines of fenestrations is about 0 degrees to about 180 degrees. In some embodiments, two radial lines of fenestrations is configured to form an angle of about 90 degrees. In some embodiments, two radial lines of fenestrations is configured to form an angle of about 180 degrees. In some embodiments, a lens comprising two or more radial lines of fenestrations does not comprise a toric element. For example, a lens free of a toric element comprising two radial lines of fenestrations that are distributed about 90 degrees apart may provide sufficient access of at least one fenestration to a tear meniscus (e.g., upper or lower tear meniscus) irrespective of the orientation of the lens on the eye.

In some embodiments, a lens comprises one radial line of fenestrations. In some embodiments, a lens comprises two radial lines of fenestrations. In some embodiments, a lens comprises three radial lines of fenestrations. In some embodiments, a lens comprises four radial lines of fenestrations.

In some embodiments, a lens comprising one radial line of fenestrations has a toric element. In some embodiments, the toric element positions the lens when disposed on the eye such that at least one fenestration in the radial line of fenestrations is adjacent to the upper or lower tear meniscus. In some embodiments, the toric element positions the lens such that the toric element is in a downward orientation (e.g., 6 o'clock) when the lens is worn on the eye. In some embodiments, the toric element positions the lens such that the toric element is in an upward orientation (e.g., 12 o'clock) when the lens is worn on the eye.

In some embodiments, at least one fenestration on a lens is adjacent to the tear meniscus. In some embodiments, at least one fenestration of one or more fenestrations on a lens has access to the tear fluid from a tear meniscus (e.g., upper meniscus or lower meniscus) constantly during wear. In some embodiments, at least two fenestrations of one or more fenestrations on a lens is adjacent to the tear meniscus. In some embodiments, at least two fenestrations of one or more fenestrations on a lens has access to the tear fluid from a tear meniscus (e.g., upper meniscus or lower meniscus) during wear. In some embodiment, constant access to the tear meniscus refers to being adjacent or in contact with the tear meniscus for at least 70%, 75%, 80%, 85%, 90%, 95%, 96%, 97%, 98%, or 99% of the time that the user is wearing the contact lens. In some embodiment, constant access is also referred herein as constant contact, continuous contact, or continuous access.

In some embodiments, a fenestration is positioned about 4 mm to about 6 mm from the center of the lens. Because the intrapalpebral fissure (“IPF”) is typically about 10 mm during distance vision, positioning the fenestrations 5 mm+/−1 mm from the center of the lens (e.g., the fenestrations having a diameter of roughly about 8 mm to about 12 mm) may be preferred.

The fenestration(s) may have a diameter of at least about 0.01 mm, at least 0.02 mm, at least 0.03 mm, at least 0.04 mm, at least 0.05 mm, at least 0.06 mm, at least 0.07 mm, at least 0.08 mm, at least 0.09 mm, at least 0.1 mm, at least 0.2 mm, at least 0.3 mm, at least 0.4 mm, at least 0.5 mm, at least 0.6 mm, at least 0.7 mm, at least 0.8 mm, at least 0.9 mm, at least 1 mm, or any values therebetween. In some embodiments, the fenestration(s) may have a diameter of at most about 1 mm, at most 0.9 mm, at most 0.8 mm, at most 0.7 mm, at most 0.6 mm, at most 0.5 mm, at most 0.4 mm, at most 0.3 mm, at most 0.2 mm, at most 0.1 mm, at most 0.09 mm, at most 0.08 mm, at most 0.07 mm, at most 0.06 mm, at most 0.5 mm, at most 0.04 mm, at most 0.03 mm, at most 0.02 mm, at most 0.01 mm, or any values therebetween. The fenestrations may have a diameter that may be within a range defined by any two of the preceding values. For instance, the fenestrations may have a diameter from about 0.05 mm to about 1 mm. In an example, the fenestrations may have a diameter from about 0.05 mm to about 0.5 mm.

The contact lenses of the present disclosure may have at least one fenestration. The contact lens may have at least about 1, 2, 3, 4, 5, 6, 7, 8, 9, 10, 11, 12, 13, 14, 15, 16, 17, 18, 19, 20, or more fenestration(s). In some embodiments, the contact lens may have at most about 20, 19, 18, 17, 16, 15, 14, 13, 12, 11, 10, 9, 8, 7, 6, 5, 4, 3, 2, or 1 fenestration(s).

In some embodiments, a peripheral portion of the soft contacts lens is configured to conform to a surface of the eye when worn on the eye. In some embodiments, a peripheral portion of the soft contacts lens is configured to conform to a corneal surface of the eye when worn on the eye. In some embodiments, at least a portion of the peripheral portion is configured to conform to a corneal surface of the eye when the lens is placed thereon.

In some embodiments, a peripheral portion of the soft contacts lens is configured to dampen a flexure force from being transmitted to the vaulted portion.

In some embodiments, the soft contact lens comprises a juncture that is configured to dampen a flexure force from being transmitted to the vaulted portion. In some embodiments, the soft lens body has a peripheral portion, an inner portion, and a juncture between the peripheral portion and inner portion. In some embodiments, the rigidity of the juncture is less than either the peripheral portion or the inner portion, or both. In some embodiments, the juncture allows the at least a portion of the peripheral portion to conform to the corneal surface without substantially deforming the inner portion.

In some embodiments, the vaulted portion and the peripheral portion have the same tensile modulus.

In some embodiments, the vaulted portion has a higher tensile modulus than the peripheral portion. In some embodiments, the vaulted portion has a lower tensile modulus than the peripheral portion. In some embodiments, the vaulted portion has a substantially similar tensile modulus to the peripheral portion. In some embodiments, the ratio of the rigidity of the vaulted portion to the peripheral portion is from about 1:3 to about 3:1. In some embodiments, the ratio of the rigidity of the vaulted portion to the peripheral portion is from about 1:1. In some embodiments, the vaulted portion comprises a tensile modulus from about 0.1 MPa to about 4 MPa.

In some embodiments, the soft contact lens is configured to mask an astigmatism of an eye of a subject. In some embodiments, the soft contact lens may be configured to mask astigmatism up to about 2.5 diopters (D). In some embodiments, the soft contact lens is configured to mask astigmatism up to about 5 D, up to 4.75 D, up to 4.5 D, up to 4.25 D, up to 4 D, up to 3.75 D, up to 3.5 D, up to 3.25 D, up to 3 D, up to 2.75 D, up to 2.5 D, up to 2.25 D, up to 2.0 D, up to 1.75 D, up to 1.5 D, up to 1 D, up to 0.7 D, up to 0.5 D, or less. In some embodiments, the soft contact lens is configured to mask astigmatism of at least about 0.5 D, at least 0.7 D, at least 1 D, at least 1.5 D, at least 1.75 D, at least 2.0 D, at least 2.25 D, at least 2.5 D, at least 2.75 D, at least 3 D, at least 3.25 D, at least 3.5 D, at least 3.75 D, at least 4 D, at least 4.25 D, at least 4.5 D, at least 4.75 D, at least 5 D, or more. In some embodiments, the soft contact lens is configured to mask an astigmatism that is within a range defined by any two of the preceding values. In some embodiments, the astigmatism is within a range from about 2.25 D to about 2.5 D. In some embodiments, the soft contact lens is configured to mask an astigmatism in increments of 0.01 D due to the sensitivity of the soft contact lens formation and is not limited to 0.25 D increments as is customary in standard toric lens.

In some embodiments, the soft contact lens is configured such that only the spherical power of the lens is required to correct the vision of a subject in need thereof, to their best corrected visual acuity. In some embodiments, the soft contact lens is configured to mask an astigmatism such that only the spherical power of the lens is required to correct the vision of a subject in need thereof, to a visual acuity. In some embodiments, the soft contact lens is configured such that both the spherical power and the cylindrical power are required to correct the vision of a subject in need thereof.

In some embodiments, the soft contact lens is configured to correct for meridian angles of about 10 degrees to about 1 degree. In some embodiments, the soft contact lens is configured to correct meridian angles up to about 10 degrees, up to 9 degrees, up to 8 degrees, up to 7 degrees, up to 6 degrees, up to 5 degrees, up to 4 degrees, up to 3 degrees, up to 2 degrees, up to 1 degree, or less. In some cases, the soft contact lens may be configured to correct for meridian angles of at least about 1 degree, at least 2 degrees, at least 3 degrees, at least 4 degrees, at least 5 degrees, at least 6 degrees, at least 7 degrees, at least 8 degrees, at least 9 degrees, at least 10 degrees, or more. The soft contact lens may be configured to correct meridian angle that is within a range defined by any two of the preceding values. In some embodiments, the meridian angle can be within a range from about 3 to about 4 degrees.

In some embodiments, the soft contact lens is configured to correct for differences in corneal power between meridians of about 3 D to about 0 D. In some embodiments, the soft contact lens is configured to correct for differences in corneal power up to about 3 D, up to 2.9 D, up to 2.8 D, up to 2.7 D, up to 2.6 D, up to 2.5 D, up to 2.4 D, up to 2.3 D, up to 2.2 D, up to 2.1 D, up to 2 D, up to 1.9 D, up to 1.8 D, up to 1.7 D, up to 1.6 D, up to 1.5 D, up to 1.4 D, up to 1.3 D, up to 1.2D, up to 1 D, up to 0.9 D, up to 0.8 D, up to 0.7 D, up to 0.6 D, up to 0.5 D, up to 0.4 D, up to 0.3 D, up to 0.2 D, up to 0.1 D, or less. In some examples, the soft contact lens may be configured to correct for differences in corneal power of at least about 0.1 D, at least 0.2 D, at least 0.3 D, at least 0.4 D, at least 0.5 D, at least 0.6 D, at least 0.7 D, at least 0.8 D, at least 0.9 D, at least 1 D, at least 1.1 D, at least 1.2 D, at least 1.3 D, at least 1.4 D, at least 1.5 D, at least 1.6 D, at least 1.7 D, at least 1.8 D, at least 1.9 D, at least 2 D, at least 2.1 D, at least 2.2 D, at least 2.3 D, at least 2.4 D 2.5 D, at least 2.6 D, at least 2.7 D, at least 2.8 D, at least 2.9 D, at least 3 D, or more. The soft contact lens may be configured to correct for differences in corneal power that is within a range defined by any two of the preceding values. In some embodiments, the difference in corneal power is within a range from about 0.5 D and about 2.5 D.

In some embodiments, a wall forming the fenestration may have various shapes. In some embodiments, a wall forming the fenestration has a conical shape. In some embodiments, a wall forming the fenestration has a shape of a frustum of a cone. In some embodiments, a wall forming the fenestration has a rounded shape. In some embodiments, a wall forming the fenestration has a cylindrical shape. In some embodiments, a wall forming the fenestration has a rectangular shape. In some embodiments, the fenestration has an opening of the fenestration to the anterior surface has a wider diameter than an opening of the fenestration to the posterior surface. In some embodiments, the wider diameter of the opening of the fenestration to the anterior surface allows for improved fluid flow than when the opening of the fenestration to the anterior surface has a narrower diameter. In some embodiments, the fenestration has an opening of the fenestration to the anterior surface has a substantially similar diameter as an opening of the fenestration to the posterior surface. In some embodiments, the fenestration has an opening of the fenestration to the anterior surface has a smaller diameter than an opening of the fenestration to the posterior surface.

### Kits

Provided herein are kits for of correcting an ocular refractive error of an eye, the kit comprising a soft contact lens as disclosed herein. In some embodiments, the kit further comprises an instruction for use.

### Method of Use

In an aspect of the present disclosure is a method of correcting an ocular refractive error of an eye using a soft contact lens as disclosed herein.

In some embodiments, the soft contact lenses may correct (i.e., mask) an ocular refractive error. In some embodiments, the soft contact lenses may correct (i.e., mask) an ocular refractive error by at least about 20%, at least 30%, at least 40%, at least 50%, at least 60%, at least 65%, at least 70%, at least 75%, at least 80%, at least 85%, at least 90%, at least 95%, at least 99%, at least or more. In some embodiments, the soft contact lens may correct an ocular refractive error by about 20% or more. In some embodiments, the soft contact lens may correct an ocular refractive error by about 25% or more. In some embodiments, the soft contact lens may correct an ocular refractive error by about 90% or more. In some embodiments, the soft contact lens may correct an ocular refractive error by about 95% or more. In some cases, the soft contact lens may mask an ocular refractive error by at most about 99%, 95%, 90%, 85%, 80%, 75%, 70%, 65%, 60%, 50%, 40%, 30%, 20%, or less. In some embodiments, correcting (i.e., mask) an ocular refractive error by a certain percentage refers to increasing the visual acuity as compared to that of a normal visual acuity (e.g., 6/6 or 20/20 vision).

In some embodiments, the soft contact lenses may correct (i.e., mask) an astigmatism. In some embodiments, the soft contact lenses may correct (i.e., mask) an astigmatism by at least about 20%, at least 30%, at least 40%, at least 50%, at least 60%, at least 65%, at least 70%, at least 75%, at least 80%, at least 85%, at least 90%, at least 95%, at least 99%, at least or more. In some embodiments, the soft contact lens may correct an astigmatism by about 20% or more. In some embodiments, the soft contact lens may correct an astigmatism by about 25% or more. In some embodiments, the soft contact lens may correct an astigmatism by about 90% or more. In some embodiments, the soft contact lens may correct an astigmatism by about 95% or more. In some cases, the contact lenses may mask an astigmatism by at most about 99%, 95%, 90%, 85%, 80%, 75%, 70%, 65%, 60%, 50%, 40%, 30%, 20%, or less. In some embodiments, correcting (i.e., mask) an astigmatism by a certain percentage refers to increasing the visual acuity as compared to that of a normal visual acuity (e.g., 6/6 or 20/20 vision).

In some embodiments, a soft contact lens may mask astigmatism up to 1 Diopter (D). In some embodiments, the soft contact lens may also mask an astigmatism up to 2 D. In some embodiments, the soft contact lens may also mask an astigmatism up to 3 D. In some embodiments, the soft contact lens may also mask an astigmatism up to 4 D. The soft contact lenses may mask astigmatism by an amount that is within a range defined by any two of the preceding values. In some embodiments, the soft contact lens masks an astigmatism between 1 D and 1.25 D. In some embodiments, the soft contact lens masks an astigmatism between 0.25 D and 1.25 D. In some embodiments, the soft contact lens masks an astigmatism between 0.5 D and 2.5 D. In some embodiments, the soft contact lens masks an astigmatism between 0.1 D and 5 D.

In some embodiments, the lens of the disclosure reduces the number of different contact lenses needed to be manufactured and stored. In some embodiments, the soft contact lenses may reduce stock keeping unit (SKU) requirements. In some embodiments, the soft contact lenses may reduce stock keeping unit (SKU) requirements by at least about 30%, at least 40%, at least 50%, at least 60%, at least 70%, at least 80%, at least 90%, at least 95%, at least 99%, or more compared to soft toric contact lenses or other conventional contact lenses. In some embodiments, the soft contact lenses may reduce SKU requirements by at most about 99%, at most 95%, at most 90%, at most 80%, at most 70%, at most 60%, at most 50%, or less compared to soft toric contact lenses or other conventional contact lenses. In some embodiments, a soft contact lens provided herein may reduce SKUs requirements by at least 50%. In some embodiments, a soft contact lens provided herein may reduce SKUs requirements by at least 80%. In some embodiments, a soft contact lens provided herein may reduce SKUs requirements by up to about 95%. The contact lenses may reduce SKU requirements by an amount that is within a range defined by any two of the preceding values. For example, soft toric contact lenses may require greater than 4000 SKUs, and the soft contact lenses described herein may require about 500 SKU, or less. In some embodiments, the lens described here enables reduction in SKUs in at least an order of magnitude and up to two orders of magnitudes to cover the spectrum of powers between-9 diopters and +6 diopters.

In some embodiments, the soft contact lens may reduce the need for glasses. In some embodiments, the soft contact lens may reduce the use of soft contact lens in tandem with glasses.

In some embodiments, the soft contact lens may reduce the required fitting time or chair time at the eye care professional, e.g., the time it takes for the user to find the lens prescription that corrects the refractive error to their satisfaction. In some embodiments, the fitting time is reduced as there are fewer lens options to try and/or a single design of the lenses provided herein is configured to correct a wide range of refractive errors. In some embodiments, fitting time is reduced by about 25% or more. In some embodiments, fitting time is reduced by about 50% or more. In some embodiments, fitting time is reduced by about 80% or more. In some embodiments, fitting time is reduced by about 90% or more. In some embodiments, the lens does not require fitting.

In some embodiments, the contact lens may reduce the number of visits to an eye care professional until the final lens fit is determined. In some embodiments, the number of visits to the eye care profession is reduced by about 25% or more. In some embodiments, the number of visits to the eye care profession is reduced by about 50% or more. In some embodiments, the number of visits to the eye care profession is reduced by about 80% or more. In some embodiments, the number of visits to the eye care profession is reduced by at least 1, 2, 3, 4, or 5 visits.

### Method for Creating Fenestrations and Grooves

Provided herein is a method of preparing a soft contact lens for correcting an ocular refractive error of an eye, the method comprising forming a fenestration through anterior surface to a posterior surface of the soft contact lens.

In some embodiments, a wall forming the fenestration has a conical shape. In some embodiments, a wall forming the fenestration has a shape of a frustum of a cone.

In some embodiments, a wall forming the fenestration has a rounded shape. In some embodiments, a wall forming the fenestration has a cylindrical shape.

In some embodiments, a wall forming the fenestration has a rectangular shape.

In some embodiments, the fenestration is formed such that an opening of the fenestration to the anterior surface has a wider diameter than an opening of the fenestration to the posterior surface. In some embodiments, the wider diameter of the opening of the fenestration to the anterior surface allows for improved fluid flow than when the opening of the fenestration to the anterior surface has a narrower diameter.

In some embodiments, the fenestration is formed such that an opening of the fenestration to the anterior surface has a substantially similar diameter as an opening of the fenestration to the posterior surface. In some embodiments, the fenestration is formed such that an opening of the fenestration to the anterior surface has a smaller diameter than an opening of the fenestration to the posterior surface.

In some embodiments, the method further comprises forming a groove. In some embodiments, the groove is on a posterior surface of the masking lens. In some embodiments, the groove is formed such that the groove has a rounded surface. In some embodiments, the groove has a wider base on the posterior surface than a cross-section closer to the anterior surface of the lens. In some embodiments, the groove is formed by a mold. In some embodiments, the groove is formed by machining. In some embodiments, the groove is formed by chemical etching. In some embodiments, the groove is formed by laser etching. In some embodiments, the groove is formed by methods other than molding or etching as will be understood by one of ordinary skill in the art based on the teachings herein.

In some embodiments, the fenestration is formed by a mold. In some embodiments, the fenestration is formed by machining. In some embodiments, the fenestration is formed by chemical etching. In some embodiments, the fenestration is formed by laser etching. In some embodiments, the fenestration is formed by methods other than molding or etching as will be understood by one of ordinary skill in the art based on the teachings herein.

In some embodiments, the surface is coated. In some embodiments, the coating improves lubrication of the lens. In some embodiments, the improved lubrication improves wearer comfort. In some embodiments, the coating has a thickness sufficient to smooth over the edges of a fenestration or a groove. In some embodiments, the thickness is about 1 μm to about 5 μm. In some embodiments, the thickness is at least about 1 μm, 2 μm, 3 μm, 4 μm, 5 μm, or more. In some embodiments, the thickness is at most about 5 μm, 4 μm, 3 μm, 2 μm, 1 μm, or less.

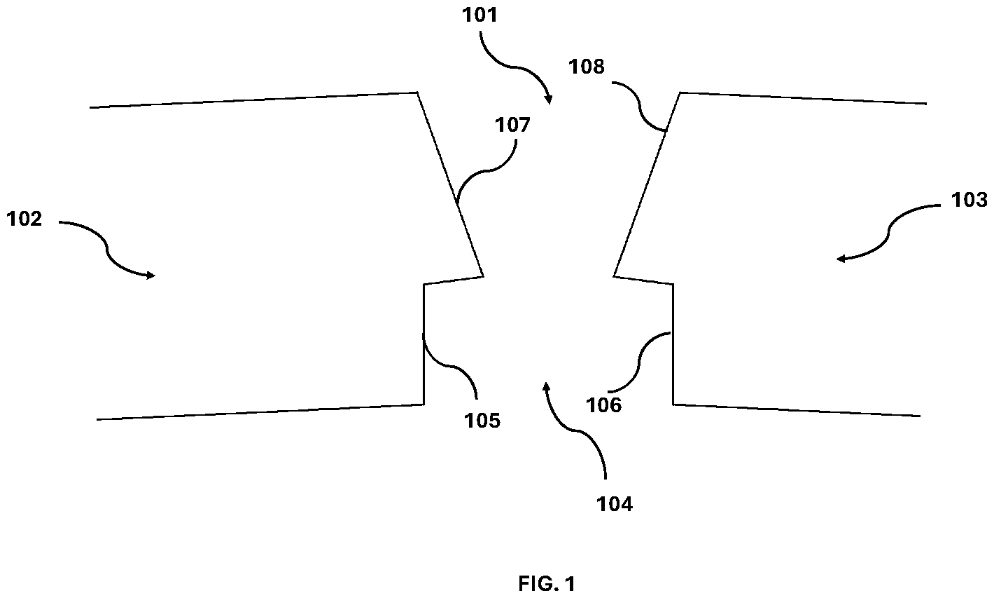

FIGS. 1-7 illustrate soft contact lens designs comprising a groove and/or a fenestration and mold designs for creating grooves and fenestrations as disclosed herein.

FIG. 1 shows a cross sectional view of a soft contact lens comprising a fenestration and a groove. In some embodiments, a soft contact lens 102, 103 comprises a fenestration 101 and a groove 104. In some embodiments, the fenestration has an anterior opening. In some embodiments, the groove has a posterior opening. In some embodiments, a wall 107, 108 forming the fenestration has a conical shape. In some embodiments, a wall 107, 108 forming the fenestration has a truncated conical shape. In some embodiments, a wall 107, 108 forming the fenestration has a shape that is a frustum of a cone. In some embodiments, a wall 105, 106 forming the groove has a linear edge. In some embodiments, a wall 105, 106 forming the groove has a straight edge. In some embodiments, a fenestration 101 is on an anterior surface of the lens body 102, 103. In some embodiments, a groove 104 is on a posterior surface of the lens body 102, 103.

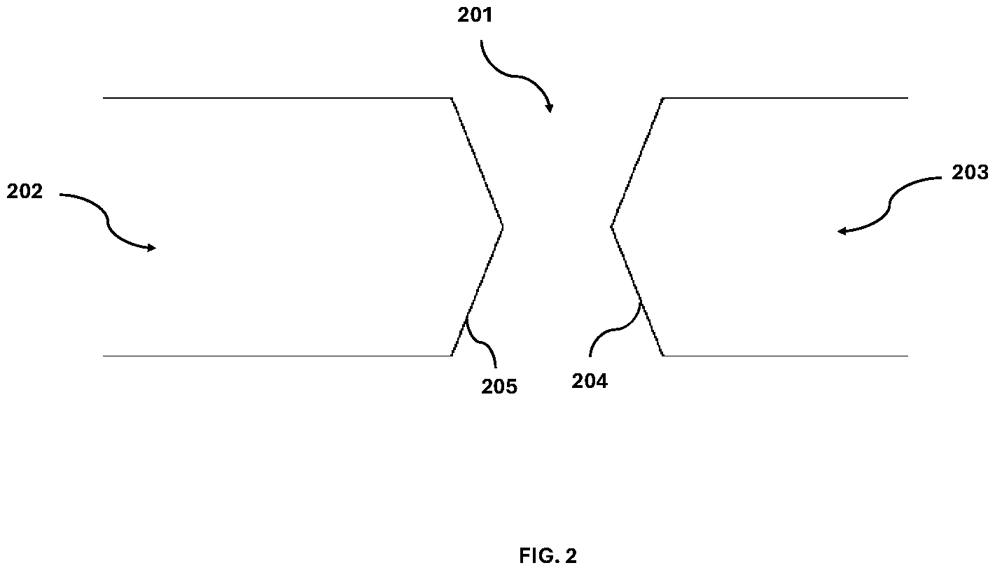

FIG. 2 shows a cross sectional view of a soft contact lens comprising a fenestration. In some embodiments, a soft contact lens body 202, 203 comprises a fenestration 201. In some embodiments, a wall 204, 205 forming the fenestration has a conical shape. In some embodiments, a wall 204, 205 forming the fenestration has a shape of a frustum of a cone. In some embodiments, the fenestration has an anterior opening of a substantially similar diameter as the posterior opening of the fenestration.

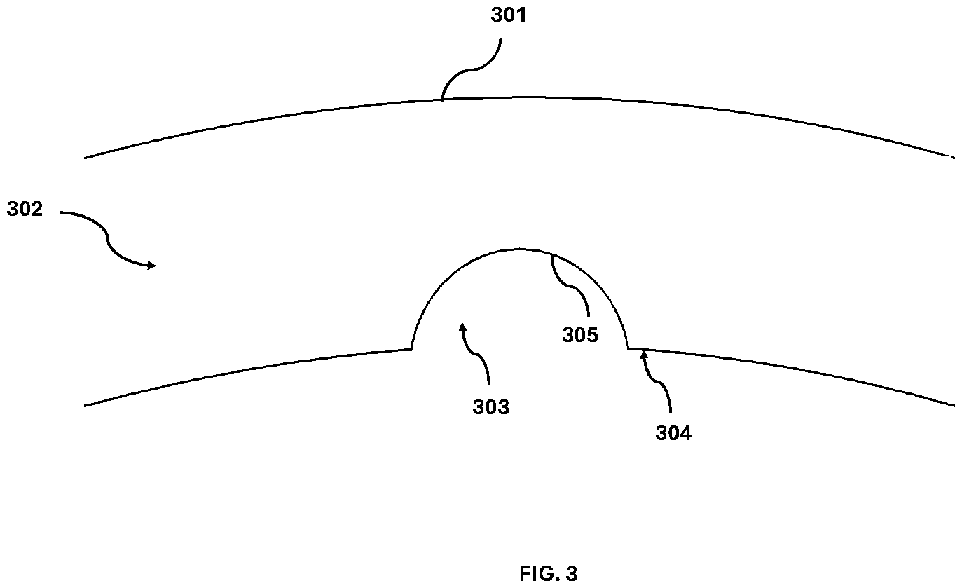

FIG. 3 shows a cross sectional view of a soft contact lens comprising a groove. In some embodiments, the soft contact lens comprises a groove 303. In some embodiments, an anterior surface 301 of a soft contact lens 302 does not have a groove. In some embodiments, an anterior surface 301 of a soft contact lens 302 does not have a fenestration. In some embodiments, a posterior surface 304 of a soft contact lens 302 has a groove 303. In some embodiments, the wall 305 forming the groove 303 has a rounded shape.

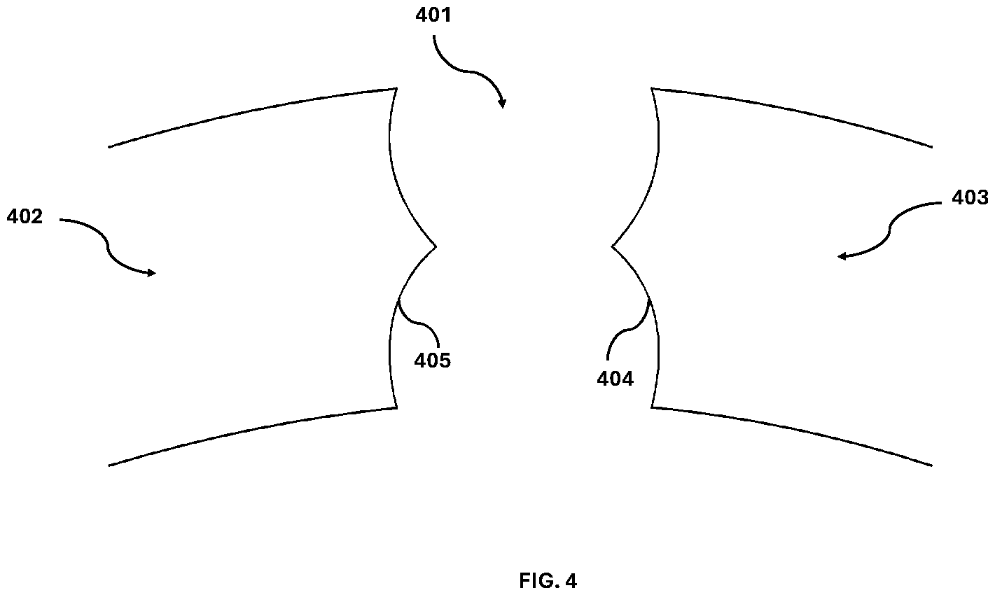

FIG. 4 shows a cross sectional view of a soft contact lens comprising a fenestration. In some embodiments is a fenestration 401 in the middle of lens body 402 and 403. In some embodiments, a wall 404, 405 forming the fenestration has a rounded shape. In some embodiments, the wall 404, 405 forming the fenestration is substantially hourglass shaped. In some embodiments, the anterior opening of the fenestration shows a substantially similar diameter as the posterior opening of the fenestration.

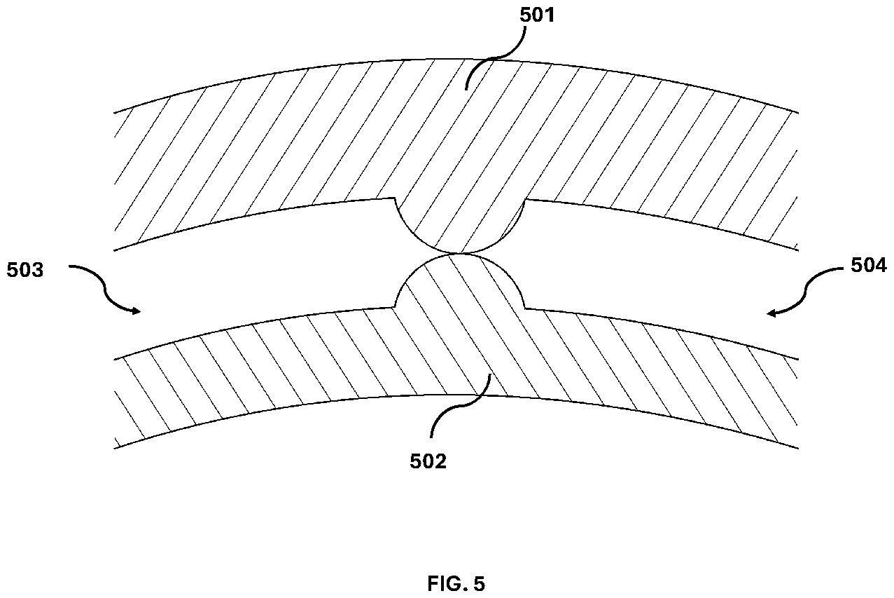

FIG. 5 shows a mold design for a soft contact lens comprising a fenestration. In some embodiments, the anterior opening of the fenestration shows a substantially similar diameter as the posterior opening of the fenestration. In some embodiments, a first mold 501 and a second mold 502 come together to create a fenestration in the lens body 503, 504.

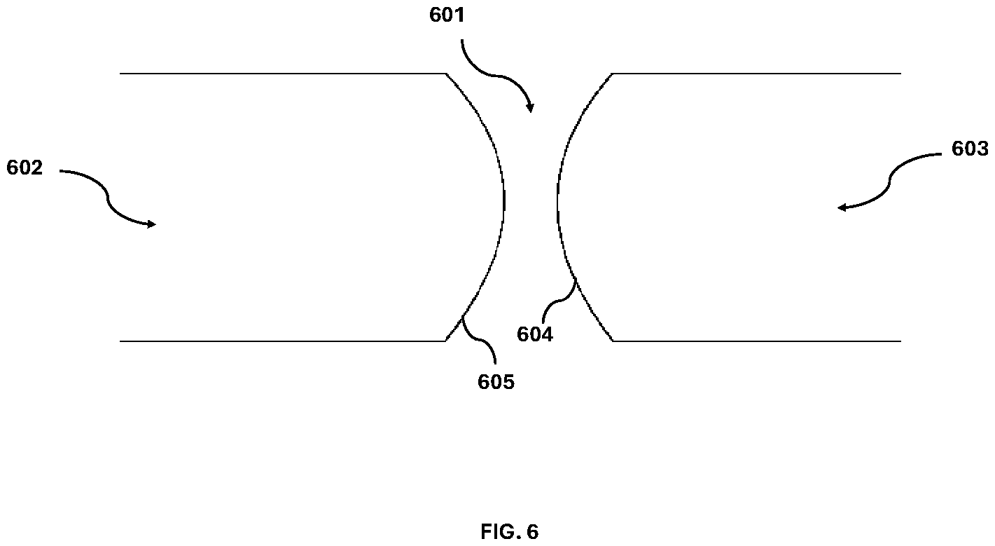

FIG. 6 shows a cross sectional view of a soft contact lens comprising a fenestration. In some embodiments is a fenestration 601 in the middle of lens body 602 and 603. In some embodiments, a wall 604, 605 forming a fenestration is a rounded shape.

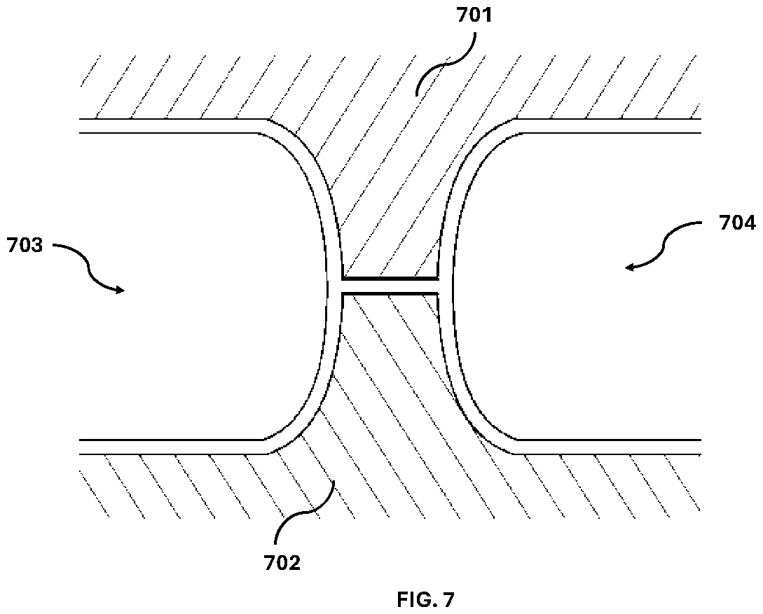

FIG. 7 shows a mold design for a soft contact lens comprising a fenestration. In some embodiments, a first mold 701 and a second mold 702 come together to create a fenestration in the lens body 703, 704.

### Method for Creating Differential Material Properties

In an aspect of the present disclosure is a method of preparing a soft contact lens for correcting an ocular refractive error of an eye, the method comprising forming the soft contact lens comprising an inner portion and a peripheral portion, wherein the inner portion has a material property different from a material property of the peripheral portion.

In some embodiments, the material property of the inner portion is higher than the material property of the peripheral portion. In some embodiments, the material property of the inner portion is imparted by additional curing, polymerizing, cross-linking, or a combination thereof to the inner portion than the peripheral portion. In some embodiments, the inner portion has a higher cross-link density than the peripheral portion.

In some embodiments, the material property of the inner portion and the material property of the peripheral portion comprise rigidity, elasticity, tensile modulus, or compressive modulus.

In some embodiments, the soft contact lens has a uniform tensile modulus. In some embodiments, the lens material i.e., the material of the soft contact lens) comprises a tensile modulus within a range from about 0.1 to about 10 MPa, such that the lens conforms at least partially to the astigmatism or high order aberration. In some embodiments, lens material has a tensile modulus is at least about 0.1 megapascals (MPa), at least 0.2 MPa, at least 0.3 MPa, at least 0.4 MPa, at least 0.5 MPa, at least 0.6 MPa, at least 0.7 MPa, at least 0.8 MPa, at least 0.9 MPa, at least 1 MPa, at least 1.1 MPa, at least 1.2 MPa, at least 1.3 MPa, at least 1.4 MPa, at least 1.5 MPa, at least 1.6 MPa, at least 1.7 MPa, at least 1.8 MPa, at least 1.9 MPa, at least 2 MPa, at least 2.1 MPa, at least 2.2 MPa, at least 2.3 MPa, at least 2.4 MPa, at least 2.5 MPa, at least 2.6 MPa, at least 2.7 MPa, at least 2.8 MPa, at least 2.9 MPa, at least 3 MPa, at least 4 MPa, at least 5 MPa, at least 6 MPa, at least 7 MPa, at least 8 MPa, at least 9 MPa, at least 10 MPa, at least or more. In some embodiments, the tensile modulus is at most about 10 MPa, at most 9 MPa, at most 8 MPa, at most 7 MPa, at most 6 MPa, at most 5 MPa, at most 4 MPa, at most 3 MPa, at most 2.9 MPa, at most 2.8 MPa, at most 2.7 MPa, at most 2.6 MPa, at most 2.5 MPa, at most 2.4 MPa, at most 2.3 MPa, at most 2.2 MPa, at most 2.1 MPa, at most 2 MPa, at most 1.9 MPa, at most 1.8 MPa, at most 1.7 MPa, at most 1.6 MPa, at most 1.5 MPa, at most 1.4 MPa, at most 1.3 MPa, at most 1.2 MPa, at most 1.1 MPa, at most 1 MPa, at most 0.9 MPa, at most 0.8 MPa, at most 0.7 MPa, at most 0.6 MPa, at most 0.5 MPa, at most 0.4 MPa, at most 0.3 MPa, at most 0.2 MPa, at most 0.1 MPa, or less. In some embodiments, the covering/lens material comprises a tensile modulus that is within a range defined by any two of the preceding values. In some embodiments, the covering/lens material comprises a tensile modulus from about 0.1 MPa to about 4 MPa. In some embodiments, the tensile modulus of at least one of the inner portion or the peripheral portion ranges from about 0.1 Megapascals (MPa) to about 4 MPa. In some embodiments, the tensile modulus of the inner portion ranges from about 0.1 Megapascals (MPa) to about 4 MPa. In some embodiments, the tensile modulus of the peripheral portion ranges from about 0.1 Megapascals (MPa) to about 4 MPa.

In some embodiments, ratio of the tensile modulus of the inner portion to the peripheral portion is about 10:1 to about 1:10. In some embodiments, ratio of the tensile modulus of the inner portion to the peripheral portion is about 3:1 to about 1:3. In some embodiments, ratio of the tensile modulus of the inner portion to the peripheral portion is about 2:1 to about 1:2. In some embodiments, ratio of the tensile modulus of the inner portion to the peripheral portion is about 1:1.

In some embodiments, ratio of the tensile strength of the inner portion to the peripheral portion is about 10:1 to about 1:10. In some embodiments, ratio of the tensile strength of the inner portion to the peripheral portion is about 3:1 to about 1:3. In some embodiments, ratio of the tensile strength of the inner portion to the peripheral portion is about 2:1 to about 1:2. In some embodiments, ratio of the tensile strength of the inner portion to the peripheral portion is about 1:1.

In some embodiments, the inner portion is formed by curing, polymerizing, cross-linking, or a combination thereof. In some embodiments, the curing comprises applying heat, a UV light, an electromagnetic energy, or moisture, or a combination thereof. In some embodiments, the curing comprises applying heat. In some embodiments, the curing comprises applying UV light. In some embodiments, the curing comprises applying electromagnetic energy. In some embodiments, the curing comprises applying moisture.

In some embodiments, the inner portion has a cross-linking initiator during formation. In some embodiments, the cross-linking initiator is activatable by heat, a UV light, an electromagnetic energy, or moisture, or a combination thereof. In some embodiments, the cross-linking initiator is activatable by heat. In some embodiments, the cross-linking initiator is activatable by UV light. In some embodiments, the cross-linking initiator is activatable by electromagnetic energy. In some embodiments, the cross-linking initiator is activatable by moisture.

In some embodiments, the method comprises covering a portion of the lens such that a portion receives less heat, a UV light, an electromagnetic energy, or moisture, or a combination thereof than an uncovered portion.

In some embodiments, the method comprises covering a portion of the lens such that an uncovered portion is selectively cured, polymerized, or cross-linked.

In some embodiments, the masking lens comprises a hydrogel. In some embodiments, the masking lens comprise a silicone hydrogel.

In some embodiments, the surface is coated. In some embodiments, the coating improves lubrication of the lens. In some embodiments, the improved lubrication improves wearer comfort. In some embodiments, the coating has a thickness sufficient to smooth over the edges of a fenestration or a groove. In some embodiments, the thickness is about 1 μm to about 5 μm. In some embodiments, the thickness is at least about 1 μm, 2 μm, 3 μm, 4 μm, 5 μm, or more. In some embodiments, the thickness is at most about 5 μm, 4 μm, 3 μm, 2 μm, 1 μm, or less.

While it may be advantageous to have a single material to build a soft contact lens, having different rigidities or other material properties such as elasticity in different regions may serve to enhance the lens function.

In some embodiments, the soft contact lens comprises a central region and a peripheral region. In some embodiments, the central region may be cured, polymerized, or cross-linked in a manner that causes the central region to have a higher Young's modulus than the peripheral region. Such curing can be achieved by means of cross-linking using energy such as heat, UV light, or other electromagnetic energy source. Additionally, or alternatively, the material may be cross-linked by moisture. The increased modulus may be achieved by imparting more cross-linking stimulus into the central region than the periphery. Additionally, or alternatively, the increased modulus can be achieved by adding more cross-linking initiator to the central region relative to the peripheral region. Initiator may be activatable by heat, UV light, or other electromagnetic energy source. Additionally, or alternatively, the initiator may be activated by moisture. The activation method of the added initiator may be the same or different than that of the bulk material. The increased energy and/or increased initiator concentration may lead to increased cross-link density in the central region causing it to have a higher modulus. In cases where the central area is more rigid than the periphery may increase the ability of the lens to vault over steeper areas of the cornea. Additionally, or alternatively, it may also allow for a thinner lens that functions similar to a lens with increased thickness but with reduced modulus. The softer periphery may reduce shape irregularity transfer to the center of the lens caused by the cornea on the periphery of the lens. In another embodiment, the center may have similar thickness and/or curing but reduced curing in the periphery may serve the same purpose. Hence, in the manufacturing process, a fixture to allow selective curing of different regions is advantageous.

In some embodiments, a fixture may be placed such that energy, (e.g., UV light), is selectively exposed to one region of the lens (e.g., center) more than other regions of the lens (e.g., periphery). In another embodiment, the source of energy is used such that it is projected with higher intensity towards certain regions (e.g., the center) and less to other regions (e.g., the periphery)

In some embodiments, the selective curing is targeted towards areas in the juncture between the central region of the lens and the peripheral region of the lens such that the juncture is less cured than it is in adjacent areas.

It may be advantageous to use materials that are amendable to such processes. For example, hydrogels, silicone hydrogels, and silicone elastomers.

In some embodiments, the masking lens may include hydrogel and silicone hydrogel coatings that can provide a uniform posterior surface chemistry even if the lens has heterogenous chemistry from differential curing. The coating may aid in lubrication of the lens to improve comfort. Additionally, the coating may have sufficient thickness (e.g., 1-5 um) to smooth over potentially rough edges of fenestrations and grooves.

In some embodiments, the masking lens design is made with either grooves or fenestration or both which allow fluid movement between the anterior and posterior area of the lens. Following a blink, fluid should rapidly flow from areas anterior to the lens such as the anterior tear film or the tear meniscus to allow the regions of the lens that are covering the steeper regions of the cornea to vault over the cornea. It was discovered that better fluid movement may occur when the one or more fenestrations are conical or rounded, such that an opening of the one or more fenestrations to the anterior surface of the lens have a wider diameter than an opening towards the groove of the posterior side of lens or an opening to any other fenestrations within the lens. It was further discovered that fluid may flow better when the groove is shaped in a rounded fashion such that the groove's base on the posterior surface of the eye is wider than the base on the inside of the lens for similar cross sectional surface area grooves. Mold designs for create such grooves and fenestrations designs are also provided.

### Definitions

Unless otherwise defined, all technical terms used herein have the same meaning as commonly understood by one of ordinary skill in the art to which this disclosure belongs. As used herein, the singular forms “a,” “an,” and “the” include plural references unless the context clearly indicates otherwise. Any reference to “or” herein is intended to encompass “and/or” unless otherwise stated. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present disclosure.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” “less than or equal to,” or “at most” precedes the first numerical value in a series of two or more numerical values, the term “no more than,” “less than,” “less than or equal to,” or “at most” applies to each of the numerical values in that series of numerical values. For example, less than or equal to 3, 2, or 1 is equivalent to less than or equal to 3, less than or equal to 2, or less than or equal to 1.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Many of the features of the present disclosure are described in relation to the anatomy of the eye of a subject. The eye includes several tissues that allow a subject or an individual to see. The subject may be an animal. The subject may be a human, such as a human patient. The subject may be in need of vision treatment, such as treatment for one or more refractive errors of the eye, including myopia, hyperopia, astigmatism, coma or comatic aberration, or other optical aberrations. The cornea of the eye is an anterior region of the eye that is clear in healthy eyes and refracts light in combination with the natural lens of the eye to focus light on the retina. The retina is a posterior region of the eye that senses the light focused thereon and transmits signals indicative of the focused light to the brain, which forms an image based on the sensed and focused light. The cornea includes an outer layer of tissue, the epithelium, which protects the underlying tissues of the cornea, such as Bowman's membrane, the stroma and nerve fibers that extend into the stroma and Bowman's membrane. A healthy eye includes a tear film disposed over the epithelium. The tear film can smooth small irregularities of the epithelium to provide an optically smooth surface. The tear film is shaped substantially by the shape of the underlying epithelium, stroma, and Bowman's membrane, if present. The tear film comprises a liquid that is mostly water but also includes additional components, such as mucoids and lipids. The many nerve fibers of the cornea provide sensation to promote blinking that can cover the cornea with the tear film. The nerve fibers also sense pain so that a subject will normally avoid trauma to the cornea and also avoid direct contact of an object to the cornea.

The current disclosure is directed to a contact lens for the treatment of refractive error. A person (e.g., patient) having a refractive error of the eye often has poor vision, such as a blurred or distorted vision, as the eye is unable to focus the light onto the retina. Common refractive errors include, but are not limited to, myopia (nearsightedness), hyperopia (farsightedness), presbyopia, and astigmatism. Astigmatism is often associated with an irregularly shaped cornea, where the non-spherical or variable curvature of the cornea causes light rays to focus at different points on the retina. In some cases, astigmatism may be associated with other eye conditions, such as keratoconus, corneal lesions, scars, and prior corneal surgery, or other refractive errors. In some cases, refractive errors comprise higher order aberrations (e.g., third or higher) that are difficult to correct by cylinder or spherical corrections. These higher order aberrations include, but are not limited to, corneal coma, trefoil aberration, and spherical aberration.

### EXAMPLES

The embodiments of the present disclosure now being generally described, it will more readily be understood to by reference to the following examples which are included merely for the purpose of illustration of certain aspects and embodiments of the present disclosure and are not intended to limit the scope of the present disclosure in any way.

### Example 1: No Correction

Provided herein is a use case of a subject suffering from an optical aberration of an eye in which the subject does not receive correction for an optical aberration of the eye. The subject may suffer from any one or more of the following optical aberrations: astigmatism, myopia, presbyopia, spherical aberration, coma, and trefoil. As a result of the optical aberration and further not receiving correction, the wearer experiences one or more of reduced visual acuity, visual fatigue, poor quality of vision, headaches, eye strain, squinting, and more. The subject experiences a decreased quality of life from not receiving proper correction for an optical aberration of the eye.

### Example 2: Correction With Toric Lens

Provided herein is a use case of a subject suffering from astigmatism that receives overcorrection for astigmatism. In this case, the subject is fit with a toric lens. During the fitting, it is important to consider the source of the subject's astigmatism. Sources of astigmatism may include corneal astigmatism, refractive astigmatism, and residual astigmatism. Depending on the source of astigmatism, the optical power may be difficult to correct substantially completely. In this case, the subject requires correction for 1.5 D of astigmatism. The subject is fitted for and prescribed toric lens for 2.0 D. The uncorrected (e.g. overcorrected) astigmatism is associated with reduced visual acuity, visual fatigue, poor quality of vision, etc. Specific symptoms may include double vision, halos, and ghosting. The subject is unsatisfied with the toric lens and may look to alternative solutions.

### Example 3: Correction With Multifocal Lens

Provided herein is a use case of a subject suffering from presbyopia that receives overcorrection for presbyopia. In this case, the subject is fit with a multifocal contact lens. Since there are multiple powers in one contact lens, the vision may not be as crisp as that with glasses or single-vision contact lenses. There may be challenges in getting the correct optical power that is strong enough in reading power without negatively impacting distance vision. The uncorrected (e.g. overcorrected) presbyopia is associated with reduced visual acuity, visual fatigue, poor quality of vision, etc. Specific symptoms may include blurry vision, halos, and eyes strain. The subject is unsatisfied with the multifocal contact lens and may look to alternative solutions.

### Example 4: Correction With Lens With Vaulted Portion and Specialty Feature

Provided herein is a non-limiting description of specific embodiments of a soft contact lens comprising a vaulted portion and a specialty feature which is worn by a wearer. The wearer may suffer from any one or more of the following optical aberrations: astigmatism, myopia, presbyopia, spherical aberration, coma, and trefoil.

In some cases, the contact lens comprises a vaulted portion and a specialty feature wherein the specialty feature is a toric feature. The vaulted portion provides vision correction by way of tear fluid that fills in the gap between the vaulted portion and the cornea. The tear fluid fills in the space by fenestrations and grooves on the back of the contact lens that aid in the fluid flow. The toric feature provides vision correction by way of a weighted portion for cylindrical correction. A wearer may have 1.25 D of astigmatism. The vaulted portion provides 1.0 D of astigmatism correction and the specialty feature provides 0.25 D of astigmatism correction. In some cases, the vaulted portion provides a majority of the astigmatism correction. In some cases, the toric feature provides a fine tune correction for astigmatism.

In some cases, the contact lens comprises a vaulted portion and a specialty feature wherein the specialty feature is a multifocal feature. The vaulted portion provides vision correction by way of tear fluid that fills in the gap between the vaulted portion and the cornea. The tear fluid fills in the space by fenestrations and grooves on the back of the contact lens that aid in the fluid flow. The multifocal feature provides vision correction by way of multiple focus zones each with a different refractive power. A wearer may suffer from both astigmatism and presbyopia. A wearer may suffer from astigmatism, presbyopia, and myopia. The vaulted portion provides astigmatism correction. The multifocal feature provides for presbyopia and/or myopia correction.

In some cases, the number of lenses that an individual wearer needs to fully correct optical aberrations is decreased. In some cases, the wearer no longer needs to wear multifocal glasses with astigmatism correcting contact lens.

### Numbered Embodiments

Provided herein are numbered embodiments of the disclosure:

Embodiment 1. A soft contact lens for correcting an ocular refractive error of an eye, the soft contact lens comprising a vaulted portion and a specialty feature.

Embodiment 2. The soft contact lens of any one of the preceding embodiments, wherein a portion of the specialty feature and a portion of the vaulted portion overlaps in an optical portion of the soft contact lens.

Embodiment 3. The soft contact lens of any one of the preceding embodiments, wherein the specialty feature and the vaulted portion do not overlap.

Embodiment 4. The soft contact lens of any one of the preceding embodiments, wherein the soft contact lens comprises a continuous body (e.g., unibody).

Embodiment 5. The soft contact lens of any one of the preceding embodiments, wherein the soft contact lens is made of a single material.

Embodiment 6. The soft contact lens of any one of the preceding embodiments, wherein the single material comprises a hydrogel.

Embodiment 7. The soft contact lens of any one of the preceding embodiments, wherein the single material comprises a silicone.

Embodiment 8. The soft contact lens of any one of the preceding embodiments, wherein the single material comprises a silicone hydrogel.

Embodiment 9. The soft contact lens of any one of the preceding embodiments, wherein the specialty feature comprises a multifocal feature.

Embodiment 10. The soft contact lens of any one of the preceding embodiments, wherein the multifocal feature comprises a bifocal feature, a trifocal feature, or a progressive feature.

Embodiment 11. The soft contact lens of any one of the preceding embodiments, wherein the multifocal feature comprises an aspheric multifocal feature.

Embodiment 12. The soft contact lens of any one of the preceding embodiments, wherein the multifocal feature comprises a concentric multifocal feature.

Embodiment 13. The soft contact lens of any one of the preceding embodiments, wherein the multifocal feature comprises a segmented multifocal feature.

Embodiment 14. The soft contact lens of any one of the preceding embodiments, wherein the multifocal feature is configured to correct presbyopia.

Embodiment 15. The soft contact lens of any one of the preceding embodiments, wherein the multifocal feature provides a correction ranging from about −6 diopter (D) to about +6 D.

Embodiment 16. The soft contact lens of any one of the preceding embodiments, wherein the multifocal feature provides a correction of at least about −6 diopter (D), −5.75 D, −5.5 D, −5.25 D, −5 D, −4.75 D, −4.5 D, −4.25 D, −4 D, −3.75 D, −3.5 D, −3.25 D, −3 D, −2.75D, −2.5 D, −2.25 D, −2 D, −1.75D, −1.5 D, −1.25D, −1 D, −0.75 D, −0.5 D, −0.25 D, +0.25 D, +0.5 D, +0.75 D, +1 D, +1.25 D, +1.5 D, +1.75 D, +2 D, +2.25 D, +2.5 D, +2.75 D, +3 D, +3.25 D, +3.5 D, +4 D, +4.25 D, +4.5 D, +4.75 D, +5 D, +5.25 D, +5.5 D, +5.75 D, or +6 D.

Embodiment 17. The soft contact lens of any one of the preceding embodiments, wherein the multifocal feature provides at least about 10%, 20%, 30%, 40%, 50%, 60%, 70%, 80%, or 90% of total power correction.

Embodiment 18. The soft contact lens of any one of the preceding embodiments, wherein the multifocal feature is on an anterior portion of the soft contact lens.

Embodiment 19. The soft contact lens of any one of the preceding embodiments, wherein the specialty feature comprises a toric feature.

Embodiment 20. The soft contact lens of any one of the preceding embodiments, wherein the toric feature comprises a prism-ballast, a peri-ballast, a back toric element, or a thin-zone design, or a combination thereof.

Embodiment 21. The soft contact lens of any one of the preceding embodiments, wherein the toric feature is located in a peripheral portion of the soft contact lens.

Embodiment 22. The soft contact lens of any one of the preceding embodiments, wherein the toric feature provides a cylindrical correction.

Embodiment 23. The soft contact lens of any one of the preceding embodiments, wherein the cylindrical correction is provided by the toric feature and a tear lens formed in between the vaulted portion and the cornea.

Embodiment 24. The soft contact lens of any one of the preceding embodiments, wherein the toric feature provides a correction ranging from about −4 D to about +4 D.

Embodiment 25. The soft contact lens of any one of the preceding embodiments, wherein the toric feature provides at least about 10%, 20%, 30%, 40%, 50%, 60%, 70%, 80%, or 90% of total power correction.

Embodiment 26. The soft contact lens of any one of the preceding embodiments, wherein the toric feature provides at least a portion of a cylindrical power correction.

Embodiment 27. The soft contact lens of any one of the preceding embodiments, wherein the toric feature provides at least about 10%, 20%, 30%, 40%, 50%, 60%, 70%, 80%, or 90% of total cylindrical power correction.

Embodiment 28. The soft contact lens of any one of the preceding embodiments, wherein the vaulted portion is configured to vault over a portion of a cornea.

Embodiment 29. The soft contact lens of any one of the preceding embodiments, wherein a portion of the vaulted portion is in an optical portion of the soft contact lens.

Embodiment 30. The soft contact lens of any one of the preceding embodiments, wherein the vaulted portion is configured to be suspended above the cornea when worn on the eye.

Embodiment 31. The soft contact lens of any one of the preceding embodiments, wherein the vaulted portion is configured to form a free volume between the cornea and a posterior surface of the soft contact lens is when worn on the eye.

Embodiment 32. The soft contact lens of any one of the preceding embodiments, wherein the vaulted portion is configured to form a free volume between the vaulted portion and the cornea when worn on the eye.

Embodiment 33. The soft contact lens of any one of the preceding embodiments, wherein the free volume is configured to be filled with a fluid to form a tear lens over the cornea when worn on the eye.

Embodiment 34. The soft contact lens of any one of the preceding embodiments, wherein the tear lens provides a correction to the ocular refractive error (e.g., astigmatism) of the eye.

Embodiment 35. The soft contact lens of any one of the preceding embodiments, wherein the vaulted portion is configured to correct the ocular refractive error without respect to a rotational orientation.

Embodiment 36. The soft contact lens of any one of the preceding embodiments, wherein the vaulted portion provides a correction of a range of about −4 D to about +4 D.

Embodiment 37. The soft contact lens of any one of the preceding embodiments, wherein the vaulted portion provides at least about 10%, 20%, 30%, 40%, 50%, 60%, 70%, 80%, or 90% of a total power correction.

Embodiment 38. The soft contact lens of any one of the preceding embodiments, wherein the vaulted portion provides at least a portion of a cylindrical power correction.

Embodiment 39. The soft contact lens of any one of the preceding embodiments, wherein the vaulted portion provides at least about 10%, 20%, 30%, 40%, 50%, 60%, 70%, 80%, or 90% of total cylindrical power correction.

Embodiment 40. The soft contact lens of any one of the preceding embodiments, wherein the vaulted portion provides a first part of a total power correction and the specialty features provide a second part of the total power correction.

Embodiment 41. The soft contact lens of any one of the preceding embodiments, wherein the vaulted portion provides a first part of a total cylinder power correction and the specialty features provide a second part of the total cylinder power correction.

Embodiment 42. The soft contact lens of any one of the preceding embodiments, wherein the vaulted portion provides a correction to the ocular refractive error in combination with the tear lens that forms when the soft contact lens is worn on the eye.

Embodiment 43. The soft contact lens of any one of the preceding embodiments, wherein the tear lens provides a third part of the total power correction.

Embodiment 44. The soft contact lens of any one of the preceding embodiments, wherein the tear lens provides at least about 10%, 20%, 30%, 40%, 50%, 60%, 70%, 80%, or 90% of total cylindrical power correction.

Embodiment 45. The soft contact lens of any one of the proceeding embodiments, wherein the soft contact lens comprises a fenestration.

Embodiment 46. The soft contact lens of any one of the preceding embodiments, wherein the fenestration fluidically connects a tear film to the lenticular volume when worn on the eye.

Embodiment 47. The soft contact lens of any one of the preceding embodiments, wherein the soft contact lens comprises a groove.

Embodiment 48. The soft contact lens of any one of the preceding embodiments, wherein the groove fluidically connects the fenestration to the lenticular volume when worn on the eye.

Embodiment 49. The soft contact lens of any one of the preceding embodiments, wherein a peripheral portion of the soft contacts lens is configured to conform to a surface of the eye when worn on the eye.

Embodiment 50. The soft contact lens of any one of the preceding embodiments, wherein the vaulted portion and the peripheral portion have the same modulus.

Embodiment 51. A method of correcting an ocular refractive error of an eye using a soft contact lens of any one of preceding embodiments.

Embodiment 52. A method of preparing a soft contact lens for correcting an ocular refractive error of an eye, the method comprising forming a fenestration through anterior surface to a posterior surface of the soft contact lens.

Embodiment 53. The method of embodiment 52, wherein a wall forming the fenestration has a conical shape.

Embodiment 54. The method of embodiment 52 or 53, wherein a wall forming the fenestration has a rounded shape.

Embodiment 55. The method of any one of embodiment 52-54, wherein the fenestration is formed such that an opening of the fenestration to the anterior surface has a wider diameter than an opening of the fenestration to the posterior surface.

Embodiment 56. The method of any one of embodiment 52-55, wherein the wider diameter of the opening of the fenestration to the anterior surface allows for improved fluid flow than when the opening of the fenestration to the anterior surface has a narrower diameter.

Embodiment 57. The method of any one of embodiment 52-56, wherein the method further comprises forming a groove.

Embodiment 58. The method of any one of embodiment 52-57, wherein the groove is on a posterior surface of the masking lens.

Embodiment 59. The method of any one of embodiment 52-58, wherein the groove is formed such that the groove has a rounded surface.

Embodiment 60. The method of any one of embodiment 52-59, wherein the groove has a wider base on the posterior surface than a cross-section closer to the anterior surface of the lens.

Embodiment 61. The method of any one of embodiment 52-60, wherein the groove is formed by a mold.

Embodiment 62. The method of any one of embodiment 52-61, wherein the fenestration is formed by a mold.

Embodiment 63. The method of any one of embodiment 52-62, wherein the surface is coated.

Embodiment 64. The method of any one of embodiment 52-63, wherein the coating improves lubrication of the lens.

Embodiment 65. The method of any one of embodiment 52-64, wherein the improved lubrication improves wearer comfort.

Embodiment 66. The method of any one of embodiment 52-65, wherein the coating has a thickness sufficient to smooth over the edges of a fenestration or a groove.

Embodiment 67. The method of any one of embodiment 52-66, wherein the thickness is about 1 um to about 5 um.

Embodiment 68. A method of preparing a soft contact lens for correcting an ocular refractive error of an eye, the method comprising forming the soft contact lens comprising an inner portion and a peripheral portion, wherein the inner portion has a material property different from a material property of the peripheral portion.

Embodiment 69. The method of embodiment 68, wherein the material property of the inner portion is higher than the material property of the peripheral portion.

Embodiment 70. The method of embodiment 68 or 69, wherein the material property of the inner portion is imparted by additional curing, polymerizing, cross-linking, or a combination thereof to the inner portion than the peripheral portion.

Embodiment 71. The method of any one of embodiment 68-70, wherein the inner portion has a higher cross-link density than the peripheral portion.

Embodiment 72. The method of any one of embodiment 68-71, wherein the material property of the inner portion and the material property of the peripheral portion comprise rigidity, elasticity, tensile modulus, or compressive modulus.

Embodiment 73. The method of any one of embodiment 68-72, wherein the inner portion is formed by curing, polymerizing, cross-linking, or a combination thereof.

Embodiment 74. The method of any one of embodiment 68-73, wherein the curing comprises applying heat, a UV light, an electromagnetic energy, or moisture, or a combination thereof.

Embodiment 75. The method of any one of embodiment 68-74, wherein the inner portion has a cross-linking initiator during formation.

Embodiment 76. The method of any one of embodiment 68-75, wherein the cross-linking initiator is activatable by heat, a UV light, an electromagnetic energy, or moisture, or a combination thereof.

Embodiment 77. The method of any one of embodiment 68-76, wherein the method comprises covering a portion of the lens such that a portion receives less heat, a UV light, an electromagnetic energy, or moisture, or a combination thereof than an uncovered portion.

Embodiment 78. The method of any one of embodiment 68-77, wherein the method comprises covering a portion of the lens such that an uncovered portion is selectively cured, polymerized, or cross-linked.

Embodiment 79. The method of any one of embodiment 68-78, wherein the masking lens comprises a hydrogel.

Embodiment 80. The method of any one of embodiment 68-79, wherein the masking lens comprise a silicone hydrogel.

Embodiment 81. The method of any one of embodiment 68-80, wherein the surface is coated.

Embodiment 82. The method of any one of embodiment 68-81, wherein the coating improves lubrication of the lens.

Embodiment 83. The method of any one of embodiment 68-82, wherein the improved lubrication improves wearer comfort.

Embodiment 84. The method of any one of embodiment 68-83, wherein the coating has a thickness sufficient to smooth over the edges of a fenestration or a groove.

Embodiment 85. The method of any one of embodiment 68-84, wherein the thickness is about 1 um to about 5 um.

In the detailed description provided herein, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments, however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the disclosure and that methods and structures within the scope of these claims and their equivalents be covered thereby.

What is claimed is:

1. A soft contact lens for correcting an ocular refractive error of an eye, the soft contact lens comprising a vaulted portion and a specialty feature.

2. The soft contact lens of any one of the preceding claims, wherein a portion of the specialty feature and a portion of the vaulted portion overlaps in an optical portion of the soft contact lens.

3. The soft contact lens of any one of the preceding claims, wherein the specialty feature and the vaulted portion do not overlap.

4. The soft contact lens of any one of the preceding claims, wherein the soft contact lens comprises a continuous body (e.g., unibody).

5. The soft contact lens of any one of the preceding claims, wherein the soft contact lens is made of a single material.

6. The soft contact lens of any one of the preceding claims, wherein the single material comprises a hydrogel.

7. The soft contact lens of any one of the preceding claims, wherein the single material comprises a silicone.

8. The soft contact lens of any one of the preceding claims, wherein the single material comprises a silicone hydrogel.

9. The soft contact lens of any one of the preceding claims, wherein the specialty feature comprises a multifocal feature.

10. The soft contact lens of any one of the preceding claims, wherein the multifocal feature comprises a bifocal feature, a trifocal feature, or a progressive feature.

11. The soft contact lens of any one of the preceding claims, wherein the multifocal feature comprises an aspheric multifocal feature.

12. The soft contact lens of any one of the preceding claims, wherein the multifocal feature comprises a concentric multifocal feature.

13. The soft contact lens of any one of the preceding claims, wherein the multifocal feature comprises a segmented multifocal feature.

14. The soft contact lens of any one of the preceding claims, wherein the multifocal feature is configured to correct presbyopia.

15. The soft contact lens of any one of the preceding claims, wherein the multifocal feature provides a correction ranging from about −6 diopter (D) to about +6 D.

16. The soft contact lens of any one of the preceding claims, wherein the multifocal feature provides a correction of at least about −6 diopter (D), −5.75 D, −5.5 D, −5.25 D, −5 D, −4.75 D, −4.5 D, −4.25 D, −4 D, −3.75 D, −3.5 D, −3.25 D, −3 D, −2.75D, −2.5 D, −2.25 D, −2 D, −1.75D, −1.5 D, −1.25D, −1 D, −0.75 D, −0.5 D, −0.25 D, +0.25 D, +0.5 D, +0.75 D, +1 D, +1.25 D, +1.5 D, +1.75 D, +2 D, +2.25 D, +2.5 D, +2.75 D, +3 D, +3.25 D, +3.5 D, +4 D, +4.25 D, +4.5 D, +4.75 D, +5 D, +5.25 D, +5.5 D, +5.75 D, or +6 D.

17. The soft contact lens of any one of the preceding claims, wherein the multifocal feature provides at least about 10%, 20%, 30%, 40%, 50%, 60%, 70%, 80%, or 90% of total power correction.

18. The soft contact lens of any one of the preceding claims, wherein the multifocal feature is on an anterior portion of the soft contact lens.

19. The soft contact lens of any one of the preceding claims, wherein the specialty feature comprises a toric feature.

20. The soft contact lens of any one of the preceding claims, wherein the toric feature comprises a prism-ballast, a peri-ballast, a back toric element, or a thin-zone design, or a combination thereof.

21. The soft contact lens of any one of the preceding claims, wherein the toric feature is located in a peripheral portion of the soft contact lens.

22. The soft contact lens of any one of the preceding claims, wherein the toric feature provides a cylindrical correction.

23. The soft contact lens of any one of the preceding claims, wherein the cylindrical correction is provided by the toric feature and a tear lens formed in between the vaulted portion and the cornea.

24. The soft contact lens of any one of the preceding claims, wherein the toric feature provides a correction ranging from about −4 D to about +4 D.

25. The soft contact lens of any one of the preceding claims, wherein the toric feature provides at least about 10%, 20%, 30%, 40%, 50%, 60%, 70%, 80%, or 90% of total power correction.

26. The soft contact lens of any one of the preceding claims, wherein the toric feature provides at least a portion of a cylindrical power correction.

27. The soft contact lens of any one of the preceding claims, wherein the toric feature provides at least about 10%, 20%, 30%, 40%, 50%, 60%, 70%, 80%, or 90% of total cylindrical power correction.

28. The soft contact lens of any one of the preceding claims, wherein the vaulted portion is configured to vault over a portion of a cornea.

29. The soft contact lens of any one of the preceding claims, wherein a portion of the vaulted portion is in an optical portion of the soft contact lens.

30. The soft contact lens of any one of the preceding claims, wherein the vaulted portion is configured to be suspended above the cornea when worn on the eye.

31. The soft contact lens of any one of the preceding claims, wherein the vaulted portion is configured to form a free volume between the cornea and a posterior surface of the soft contact lens is when worn on the eye.

32. The soft contact lens of any one of the preceding claims, wherein the vaulted portion is configured to form a free volume between the vaulted portion and the cornea when worn on the eye.

33. The soft contact lens of any one of the preceding claims, wherein the free volume is configured to be filled with a fluid to form a tear lens over the cornea when worn on the eye.

34. The soft contact lens of any one of the preceding claims, wherein the tear lens provides a correction to the ocular refractive error (e.g., astigmatism) of the eye.

35. The soft contact lens of any one of the preceding claims, wherein the vaulted portion is configured to correct the ocular refractive error without respect to a rotational orientation.

36. The soft contact lens of any one of the preceding claims, wherein the vaulted portion provides a correction of a range of about −4 D to about +4 D.

37. The soft contact lens of any one of the preceding claims, wherein the vaulted portion provides at least about 10%, 20%, 30%, 40%, 50%, 60%, 70%, 80%, or 90% of a total power correction.

38. The soft contact lens of any one of the preceding claims, wherein the vaulted portion provides at least a portion of a cylindrical power correction.

39. The soft contact lens of any one of the preceding claims, wherein the vaulted portion provides at least about 10%, 20%, 30%, 40%, 50%, 60%, 70%, 80%, or 90% of total cylindrical power correction.

40. The soft contact lens of any one of the preceding claims, wherein the vaulted portion provides a first part of a total power correction and the specialty features provide a second part of the total power correction.

41. The soft contact lens of any one of the preceding claims, wherein the vaulted portion provides a first part of a total cylinder power correction and the specialty features provide a second part of the total cylinder power correction.

42. The soft contact lens of any one of the preceding claims, wherein the vaulted portion provides a correction to the ocular refractive error in combination with the tear lens that forms when the soft contact lens is worn on the eye.

43. The soft contact lens of any one of the preceding claims, wherein the tear lens provides a third part of the total power correction.

44. The soft contact lens of any one of the preceding claims, wherein the tear lens provides at least about 10%, 20%, 30%, 40%, 50%, 60%, 70%, 80%, or 90% of total cylindrical power correction.

45. The soft contact lens of any one of the proceeding claims, wherein the soft contact lens comprises a fenestration.

46. The soft contact lens of any one of the preceding claims, wherein the fenestration fluidically connects a tear film to the lenticular volume when worn on the eye.

47. The soft contact lens of any one of the preceding claims, wherein the soft contact lens comprises a groove.

48. The soft contact lens of any one of the preceding claims, wherein the groove fluidically connects the fenestration to the lenticular volume when worn on the eye.

49. The soft contact lens of any one of the preceding claims, wherein a peripheral portion of the soft contacts lens is configured to conform to a surface of the eye when worn on the eye.

50. The soft contact lens of any one of the preceding claims, wherein the vaulted portion and the peripheral portion have the same modulus.

51. A method of correcting an ocular refractive error of an eye using a soft contact lens of any one of preceding claims.
